(19) United States
(12) Patent Application Publication
(10) Pub. No.: US 2025/0329095 A1
(43) Pub. Date: Oct. 23, 2025

(54) ANIMATION RETARGETING

(71) Applicant: Tencent Technology (Shenzhen) Company Limited, Shenzhen (CN)

(72) Inventors: Yazhan ZHANG, Shenzhen (CN); Xingyan LIU, Shenzhen (CN); Zijiao ZENG, Shenzhen (CN)

(73) Assignee: Tencent Technology (Shenzhen) Company Limited, Shenzhen (CN)

(21) Appl. No.: 19/204,198

(22) Filed: May 9, 2025

Related U.S. Application Data
(63) Continuation of application No. PCT/CN2024/076178, filed on Feb. 5, 2024.

(30) Foreign Application Priority Data
Mar. 29, 2023 (CN) 202310321008.7

(51) Int. Cl. G06T 13/40

(52) U.S. Cl. CPC G06T 13/40

(57) ABSTRACT

Spatial semantics detection is performed on an animation transfer source model including N first local object BVs, to obtain a spatial semantics detection result. Based on the spatial semantics detection result and from the N first local object BVs of the first object, effective interaction BVs including a pair of first local object BVs that satisfies an animation retargeting policy are determined. From an animation transfer target model including M second local object BVs, to-be-transferred BVs that satisfy the animation retargeting policy are determined. Spatial semantics information of the effective interaction BVs is transferred to the to-be-transferred BVs, to obtain transferred BVs that carry the spatial semantics information. A model correction parameter is acquired based on the spatial semantics information. Based on the model correction parameter, model correction processing is performed on the animation transfer target model that comprises the transferred BVs, to obtain an updated animation transfer target model.

### RELATED APPLICATIONS

The present application is a continuation of International Application No. PCT/CN2024/076178, filed on Feb. 5, 2024, which claims priority to Chinese Patent Application No. 202310321008.7 filed on Mar. 29, 2023. The entire disclosures of the prior applications are hereby incorporated by reference.

### FIELD OF THE TECHNOLOGY

This application relates to the field of computer technologies, including an animation retargeting.

### BACKGROUND OF THE DISCLOSURE

An animation retargeting technology is transferring animation data of a character model (that is, an animation transfer source model) to another character model (that is, an animation transfer target model), reusing the same animation data, and omitting a process of redesigning animation data for the another character model.

Currently, animation retargeting manners are mainly as follows: A layer of additional hull mesh is assigned to a mesh of an animation transfer source model and an animation transfer target model, and vertex structure information (for example, a quantity of vertexes and a connection manner between vertexes) of topological structures corresponding to hull meshes between different character models needs to be kept the same. This means that in an animation retargeting technology in the related technology, vertexes of hull meshes assigned to the animation transfer source model need to be used as interaction points, and vertex structure information between these interaction points in the animation transfer source model is indiscriminately transferred to corresponding points having the same topological structure.

However, due to complexities of different models, a data volume of vertex structure information transferred in a retargeting process may be relatively large, causing relatively long duration consumed during animation retargeting, and further causing relatively low animation retargeting efficiency. In addition, complexities of different models are different, so that a manner of directly transferring vertex structure information easily causes a problem that animation data presented by a finally obtained animation transfer target model is inconsistent with that presented by the animation transfer source model, that is, a problem of inaccurate spatial semantics transfer in an animation retargeting process exists in the related technology.

### SUMMARY

Embodiments of this disclosure provide an animation retargeting method and apparatus, a computer device, a computer-readable storage medium, and a computer program product, not only to improve animation retargeting efficiency, but also to improve accuracy of spatial semantics transfer in an animation retargeting process.

Some aspects of the disclosure provide a method of animation retargeting. In some examples, on an animation retargeting configuration interface, an animation transfer source model associated with a first object, and an animation transfer target model associated with a second object are displayed. The first object includes at least N first local objects, the second object includes at least M second local objects, N and M are positive integers. The animation transfer source model includes N first local object bounding volumes (BVs) respectively associated with the N first local objects of the first object, and the animation transfer target model includes M second local object BVs respectively associated with the M second local objects of the second object. Spatial semantics detection is performed on the N first local object BVs, to obtain a spatial semantics detection result. Based on the spatial semantics detection result and from the N first local object BVs of the first object, effective interaction BVs including a pair of first local object BVs that satisfies an animation retargeting policy are determined. From the M second local object BVs of the second object, to-be-transferred BVs that satisfy the animation retargeting policy are determined. Spatial semantics information of the effective interaction BVs is transferred to the to-be-transferred BVs, to obtain transferred BVs that carry the spatial semantics information. A model correction parameter is acquired based on the spatial semantics information. Based on the model correction parameter, model correction processing is performed on the animation transfer target model that comprises the transferred BVs, to obtain an updated animation transfer target model. The updated animation transfer target model is displayed on the animation retargeting configuration interface.

Some aspects of the disclosure provide an information processing apparatus for animation retargeting. The information processing apparatus includes processing circuitry configured to display, on an animation retargeting configuration interface, an animation transfer source model associated with a first object, and an animation transfer target model associated with a second object. The first object includes at least N first local objects, the second object includes at least M second local objects, N and M are positive integers. The animation transfer source model includes N first local object bounding volumes (BVs) respectively associated with the N first local objects of the first object, and the animation transfer target model includes M second local object BVs respectively associated with the M second local objects of the second object. Spatial semantics detection is performed on the N first local object BVs, to obtain a spatial semantics detection result. Based on the spatial semantics detection result and from the N first local object BVs of the first object, effective interaction BVs including a pair of first local object BVs that satisfies an animation retargeting policy are determined. From the M second local object BVs of the second object, to-be-transferred BVs that satisfy the animation retargeting policy are determined. Spatial semantics information of the effective interaction BVs is transferred to the to-be-transferred BVs, to obtain transferred BVs that carry the spatial semantics information. A model correction parameter is acquired based on the spatial semantics information. Based on the model correction parameter, model correction processing is performed on the animation transfer target model that comprises the transferred BVs, to obtain an updated animation transfer target model. The updated animation transfer target model is displayed on the animation retargeting configuration interface.

An embodiment of this disclosure provides an animation retargeting method. The method includes: displaying, on an animation retargeting configuration interface, an animation transfer source model associated with a first object, an animation transfer target model associated with a second object, N first local object bounding volumes (BVs) associated with the first object, and M second local object BVs associated with the second object, N and M being both positive integers; one first local object BV including one local object of the first object; and one second local object BV including one local object of the second object; performing spatial semantics detection on the N first local object BVs, to obtain a spatial semantics detection result; determining, based on the spatial semantics detection result, a first local object BV pair that is sorted out from the N first local object BVs and satisfies an animation retargeting policy as effective interaction BVs of the first object; determining second local object BVs that are found in the M second local object BVs and satisfy the animation retargeting policy as to-be-transferred BVs; transferring, when spatial semantics information of the effective interaction BVs is acquired based on the spatial semantics detection result, the spatial semantics information from the effective interaction BVs to the to-be-transferred BVs, to obtain transferred BVs that carry the spatial semantics information; and acquiring a model correction parameter determined from the spatial semantics information, and performing, based on the model correction parameter, model correction processing on the animation transfer target model that includes the transferred BVs, to obtain an animation transfer target model on which model correction processing is performed, and displaying the animation transfer target model on which model correction processing is performed on the animation retargeting configuration interface, where spatial semantics information of the animation transfer target model on which model correction processing is performed is kept consistent with spatial semantics information of the animation transfer source model.

An embodiment of this disclosure provides an animation retargeting apparatus. The apparatus includes: a display module, configured to display, on an animation retargeting configuration interface, an animation transfer source model associated with a first object, an animation transfer target model associated with a second object, N first local object BVs associated with the first object, and M second local object BVs associated with the second object, N and M being both positive integers; one first local object BV including one local object of the first object; and one second local object BV including one local object of the second object; a detection module, configured to perform spatial semantics detection on the N first local object BVs, to obtain a spatial semantics detection result; a sorting module, configured to determine, based on the spatial semantics detection result, a first local object BV pair that is sorted out from the N first local object BVs and satisfies an animation retargeting policy as effective interaction BVs of the first object; a search module, configured to determine second local object BVs that are found in the M second local object BVs and satisfy the animation retargeting policy as to-be-transferred BVs; a transfer module, configured to transfer, when spatial semantics information of the effective interaction BVs is acquired based on the spatial semantics detection result, the spatial semantics information from the effective interaction BVs to the to-be-transferred BVs, to obtain transferred BVs that carry the spatial semantics information; an acquiring module, configured to acquire a model correction parameter determined from the spatial semantics information; a correction module, configured to perform, based on the model correction parameter, model correction processing on the animation transfer target model that includes the transferred BVs, to obtain an animation transfer target model on which model correction processing is performed; and a model display module, configured to display the animation transfer target model on which model correction processing is performed on the animation retargeting configuration interface, spatial semantics information of the animation transfer target model on which model correction processing is performed being kept consistent with spatial semantics information of the animation transfer source model.

An embodiment of this disclosure provides a computer device, including a memory and a processor (an example of processing circuitry), the memory being connected to the processor, the memory being configured to store a computer program, and the processor being configured to invoke the computer program, to cause the computer device to perform the foregoing animation retargeting method in the embodiments of this disclosure.

An embodiment of this disclosure provides a computer-readable storage medium (e.g., non-transitory computer-readable storage medium), the computer-readable storage medium having a computer program stored therein, and the computer program being adapted to be loaded and executed by a processor, to cause a computer device having the processor to perform the foregoing animation retargeting method in the embodiments of this disclosure.

An embodiment of this disclosure provides a computer program product, the computer program product including a computer program, and the computer program being stored in a computer-readable storage medium. When a processor of a computer device reads the computer program from the computer-readable storage medium and the processor executes the computer program, the computer device is caused to perform the foregoing animation retargeting method.

In the embodiments of this disclosure, in one aspect, the computer device may construct the first local BV for the animation transfer source model and the second local BV for the animation transfer target model on the animation retargeting configuration interface, to obtain the N first local object BVs associated with the first object and the M second local object BVs associated with the second object. A spatial expression of the animation transfer source model may be formed by using the N first local object BVs, then spatial semantics detection may be performed on the N first local object BVs to obtain a spatial semantics detection result, and an effective interaction BV that satisfies the animation retargeting policy is sorted out from the N first local object BVs based on the spatial semantics detection result. In this way, the computer device may transfer spatial semantics information of the effective interaction BV to the second local object BV that satisfies the animation retargeting policy, to obtain a mapping BV. Because directly transferring the spatial semantics information of the effective interaction BV reduces a transferred data volume to some extent compared with transferring vertex structure information, the animation retargeting method in the embodiments of this disclosure can improve animation retargeting efficiency. In another aspect, a second local object BV satisfying the animation retargeting policy may be sorted out from the M second local object BVs as a to-be-transferred BV, and the spatial semantics information of the effective interaction BV is transferred to the to-be-transferred BV. That is, in the embodiments of this disclosure, the spatial semantics information of the effective interaction BV in the animation transfer source model can be relatively precisely mapped to the corresponding second local object BV in the animation transfer target model. Therefore, accuracy of spatial semantics transfer can be greatly improved in the animation retargeting process. In still another aspect, in the embodiments of this disclosure, model correction processing may be performed on the animation transfer target model including the mapping BV according to the model correction parameter determined according to the spatial semantics information, to obtain the animation transfer target model on which the model correction processing is performed. In this way, model correction processing may be automatically performed, so that spatial semantics information of the animation transfer target model on which the model correction processing is performed is kept consistent with spatial semantics information of the animation transfer source model, thereby improving animation retargeting efficiency and also improving accuracy of spatial semantics transfer in the animation retargeting process, to further ensure consistency between animation data presented by the animation transfer target model and that presented by the animation transfer source model.

### BRIEF DESCRIPTION OF THE DRAWINGS

FIG. 1 is a schematic diagram of a bounding volume hierarchy (BVH) of a model according to an embodiment of this disclosure.

FIG. 2 is a structural diagram of an animation retargeting system according to an embodiment of this disclosure.

FIG. 3A is a flowchart of an animation retargeting method according to an embodiment of this disclosure.

FIG. 3B is a schematic diagram of model correction according to an embodiment of this disclosure.

FIG. 4 is a schematic flowchart of an animation retargeting method according to an embodiment of this disclosure.

FIG. 5 is a schematic diagram of displaying a first animation transfer model pair on an animation retargeting configuration interface according to an embodiment of this disclosure.

FIG. 6 is another schematic diagram of displaying a first animation transfer model pair on an animation retargeting configuration interface according to an embodiment of this disclosure.

FIG. 7 is a schematic diagram of an animation retargeting configuration interface according to an embodiment of this disclosure.

FIG. 8 is a schematic diagram of a moving operation according to an embodiment of this disclosure.

FIG. 9 is a schematic diagram of a scaling operation according to an embodiment of this disclosure.

FIG. 10 is a schematic diagram of a rotating operation according to an embodiment of this disclosure.

FIG. 11 is a schematic flowchart of another animation retargeting method according to an embodiment of this disclosure.

FIG. 12 is a schematic diagram of closest points between spheres according to an embodiment of this disclosure.

FIG. 13 is a schematic diagram of closest points between a sphere and a capsule according to an embodiment of this disclosure.

FIG. 14 is a schematic diagram of closest points between capsules according to an embodiment of this disclosure.

FIG. 15 is a schematic diagram of a local vector of a closest point of a first effective interaction BV according to an embodiment of this disclosure.

FIG. 16 is another schematic diagram of a local vector of a closest point of a first effective interaction BV according to an embodiment of this disclosure.

FIG. 17 is a schematic diagram of determining a proportion coefficient corresponding to a closest point of a first effective interaction BV according to an embodiment of this disclosure.

FIG. 18 is a schematic diagram of determining a first position point having first spatial semantics information the same as that of a closest point of a first effective interaction BV according to an embodiment of this disclosure.

FIG. 19 is another schematic diagram of determining a first position point having first spatial semantics information the same as that of a closest point of a first effective interaction BV according to an embodiment of this disclosure.

FIG. 20 is a schematic diagram of calculation of an interaction estimation point corresponding to a first transferred BV according to an embodiment of this disclosure.

FIG. 21 is a schematic diagram of comparison between an animation transfer target model including a transferred BV and an animation transfer target model on which model correction processing is performed according to an embodiment of this disclosure.

FIG. 22 is another schematic diagram of comparison between an animation transfer target model including a transferred BV and an animation transfer target model on which model correction processing is performed according to an embodiment of this disclosure.

FIG. 23 is a schematic structural diagram of an animation retargeting apparatus according to an embodiment of this disclosure.

FIG. 24 is a schematic structural diagram of a computer device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

For ease of understanding, the following explains and describes basic concepts related to the embodiments of this disclosure:

(1) Animation retargeting can refer to an animation reusing technology. Animation retargeting allows an animation to be reused between models that share the same skeleton resource but have greatly different ratios. In brief, animation retargeting may transfer animation data of a model to another model, reuse the same animation data, and omit a process of redesigning animation data for the another model. In the embodiments of this disclosure, a model that transfers animation data may be referred to as an animation transfer source model, and a model to which animation data is transferred may be referred to as an animation transfer target model. For example, the animation retargeting may transfer animation data of a model A to another model B. In this case, the model A that transfers animation data is referred to as an animation transfer source model, and the model B to which animation data is transferred is referred to as an animation transfer target model. In the embodiments of this disclosure, the animation transfer source model is associated with a first object, and the animation transfer target model is associated with a second object. The association means that the animation transfer source model includes the first object, the animation transfer source model may be configured to present animation data corresponding to the first object, the animation transfer target model includes the second object, and the animation transfer target model may be configured to present animation data corresponding to the second object.

The first object and the second object have the same skeleton resource, that is, the first object and the second object have the same object attribute. For example, the first object and the second object may both be real characters, animation characters, or the like. For another example, the first object and the second object may be both animals. This is not limited in the embodiments of this disclosure. In the embodiments of this disclosure, the animation transfer source model and the animation transfer target model may be a game character model in a game scenario, a social character model in a social scenario, or the like. This is not limited in the embodiments of this disclosure.

In the embodiments of this disclosure, the animation transfer source model may be, for example, a model corresponding to any frame of animation data in a plurality of frames of animation data, and the animation transfer source model may be referred to as an actor model; and the plurality of frames of animation data may be obtained by using human motions or animal motions captured by an animation capture device. The animation transfer target model mainly includes a skeleton and a mesh, and a movement relationship between the skeleton and the mesh is usually a linear blend skinning (LBS) model. The LBS model is usually used as a carrier of human actions or expressions during game or movie and television production.

(2) Bounding volume (BV) can refer to a relatively simple geometry body, for example, a rectangle, a circle, a box, or a sphere. The BV may be configured for surrounding a relatively complex model. For example, the BV may be configured for wrapping some body parts of a game character model, to perform a task such as collision detection in place of the body parts. In the embodiments of this disclosure, the BV may be configured to wrap a local object of the first object and a local object of the second object. Using an example in which the first object is a character object, the BV in the embodiments of this disclosure may be configured for wrapping some character limbs of the first object. For example, the BV may be configured for surrounding the head, the waist, the chest, or the like of the first object. The BV provided in this embodiment of this disclosure may be further configured for wrapping an additional moving object. The moving object may be, for example, game equipment or social equipment. The game equipment may be, for example, a packsack or an armor. The social equipment may be, for example, a fluorescent stick.

In the embodiments of this disclosure, a BV surrounding a local object of the first object may be referred to as a first local object BV, and a BV surrounding a local object of the second object may be referred to as a second local object BV. The first local object BV and the second local object BV may be configured for spatial semantics detection and spatial semantics transfer in an animation retargeting process.

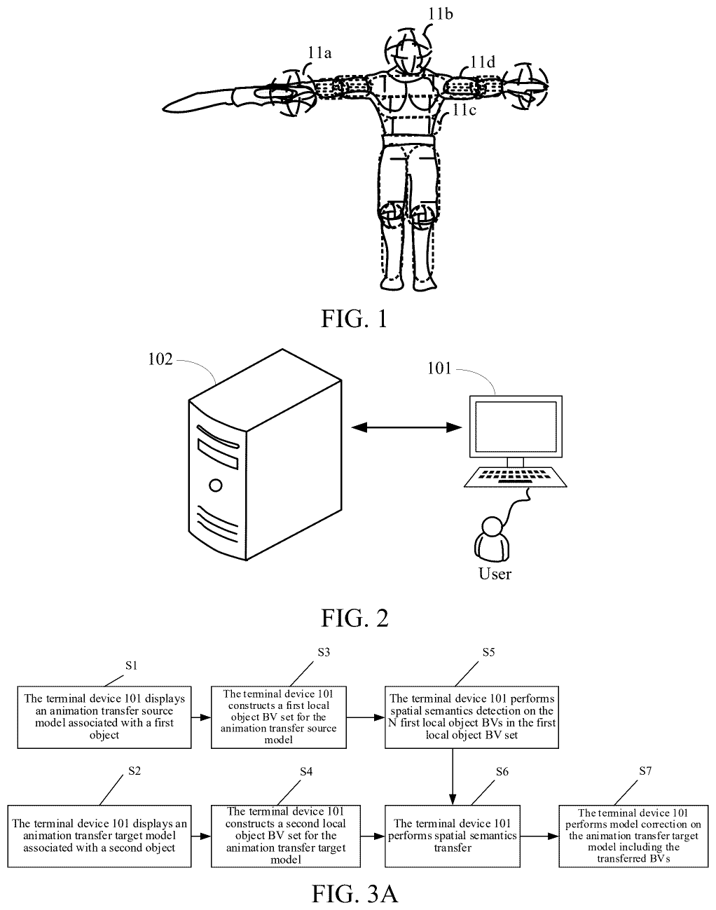

(3) Bounding volume hierarchy (BVH) can refer to that the foregoing BVs form a BV set including a tree structure in a manner such as side-by-side arrangement, embedding, or wrapping. The BVH usually serves an objective of reducing a calculation amount in a collision detection task. For example, FIG. 1 is a schematic diagram of a BVH of a model according to an embodiment of this disclosure. The BVH includes a plurality of BVs. The BV may be a sphere (for example, a sphere 11a or a sphere 11b in FIG. 1), a capsule (for example, a capsule 11c or a capsule 11d in FIG. 1), or the like. In the embodiments of this disclosure, the BVH may be configured for spatial semantics detection and spatial semantics transfer in an animation retargeting process.

In the embodiments of this disclosure, a spatial relationship between the animation transfer target model and the transfer source model may be described by using a simple geometry body or a hierarchy further forming a geometry body, thereby assisting in spatial semantics detection and spatial semantics transfer in an animation retargeting process.

(4) Spatial semantics information can refer to information describing a spatial relationship between BVs, where the spatial relationship includes feature semantics corresponding to no contact, contact, and collision, and features of the feature semantics include but are not limited to: a closest point pair between BVs, and a value or a vector such as a direction or a distance of each closest point in the closest point pair.

(5) Spatial semantics detection can refer to a process of calculating spatial semantics in a spatial geometry body set, that is, detecting spatial semantics between spatial geometry bodies included in the spatial geometry body set. In the embodiments of this disclosure, the spatial geometry body set refers to a BVH, and the spatial semantics detection refers to performing spatial semantics calculation on a BV in the BVH.

(6) Spatial semantics transfer can refer to that in an animation retargeting process, spatial semantics information of a BVH corresponding to the animation transfer source model is transferred to a BVH corresponding to the animation transfer target model by using shape and size invariant and orientation invariant criteria. In the embodiments of this disclosure, spatial semantics information transferred to the BVH corresponding to the animation transfer target model may include a closest point and a local direction (that is, a local vector) of the closest point in the BV. In the embodiments of this disclosure, if the BV is a capsule, the BV may further include a proportion coefficient of the closest point in the axial vector of the capsule. After the spatial semantics transfer is performed, an adjustment amount (that is, referred to as an adjustment vector hereinafter) required to enable the BVs of the animation transfer target model and the animation transfer source model to comply with the same spatial relationship may be calculated based on the transferred spatial semantics information. In this embodiment of this disclosure, spatial semantics transfer may also be referred to as spatial semantics mapping.

(7) Spatial semantics preservation correction can refer to model correction. The spatial semantics preservation correction means that in the animation retargeting process, the BVH in the animation transfer target model is properly adjusted to have the same spatial relationship between BV sets as the BVH in the animation transfer source model has.

(8) End-effector (EEF) can usually refer to an end of a limb of an animated character, such as a hand or a foot.

(9) Inversed kinematic (IK) can refer to a process of calculating a rotation angle of each intermediate joint according to a serial kinematic chain and a position of an EEF that are given. In the embodiments of this disclosure, through IK adjustment, a spatial relationship of a corresponding BV in the animation transfer target model may be kept consistent with a spatial relationship in the animation transfer source model. For example, in the embodiments of this disclosure, the EEF is a left hand. Correspondingly, a serial kinematic chain may be: left hand-left forearm-left upper arm.

In the embodiments of this disclosure, content of user information, for example, information such as an animation transfer source model and an animation transfer target model is involved, and if data related to the user information or enterprise information is involved, when this embodiment of this disclosure is applied to a specific product or technology, user permission or consent needs to be obtained, or the information is fuzzed, to eliminate a correspondence between the information and a user; and when collection processing of the related data is applied to an example, informed consent or independent consent of a subject of personal information is to be acquired strictly according to requirements of laws and regulations of related nations, and subsequent data use and processing behaviors are performed within the laws and regulations and the authorization scope of the subject of the personal information.

FIG. 2 is a schematic structural diagram of an animation retargeting system according to an embodiment of this disclosure. The animation retargeting system includes a terminal device 101 and a server 102. The terminal device 101 and the server 102 may be directly or indirectly connected in a wired or wireless communication manner. This is not limited in this embodiment of this disclosure herein. The terminal device in this embodiment of this disclosure may be a smartphone, a tablet computer, a notebook computer, a palmtop computer, a personal computer, a smart television, a smartwatch, an in-vehicle device, a wearable device, or the like, but is not limited thereto. The server may be an independent physical server, or may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a Content Delivery Network (CDN), and a big data and artificial intelligence platform. Quantities of terminal devices 101 and servers 102 are not limited either.

The terminal device 101 may be configured to display an animation retargeting configuration interface. A user (for example, an artist or an animation designer) may select, on the animation retargeting configuration interface, a first animation transfer model pair on which spatial semantics transfer is to be performed. The first animation transfer model pair includes an animation transfer source model associated with a first object and an animation transfer target model associated with a second object. Then, the user processes the animation transfer source model and the animation transfer target model (for example, constructs a BVH for the animation transfer source model or adjusts a position of the animation transfer target model). When the animation data of the animation transfer source model needs to be transferred to the animation transfer target model, the terminal device 101 may perform spatial semantics detection on the BVH of the animation transfer source model, then transfer spatial semantics information obtained through spatial semantics detection to the BVH corresponding to the animation transfer target model, and perform IK adjustment (that is, model correction) on the animation transfer target model to which the spatial semantics information is transferred, to obtain an animation transfer corrected model having spatial semantics information the same as that of the animation transfer source model. In addition, the animation retargeting configuration interface may be configured for displaying the animation transfer source model and the animation transfer corrected model.

Animation software (for example, MotionBuilder) is run on the terminal device 101. The animation retargeting configuration interface provided in this embodiment of this disclosure may be run and displayed in the animation software in a manner of a plug-in. Certainly, the terminal device 101 may alternatively provide software specifically configured for running and displaying the animation retargeting configuration interface. This is not limited in this embodiment of this disclosure.

The server 102 may provide technical support for a service (for example, displaying the animation retargeting configuration interface) provided by the terminal device 101. The server 102 may be configured to store target animation data that is associated with a first object (for example, a human body) and that is captured by using an animation capture device. The target animation data forms an action sequence of the first object. The target animation data may include a plurality of frames of animation data. Each frame of animation data corresponds to one action of one first object, and the action included in each frame of animation data is presented by using the animation transfer source model associated with the first object.

The animation capture device may include, but is not limited to: a camera device and a scanning device. The camera device may include an ordinary camera, a stereo camera, a light field camera, and the like. The scanning device may include a three-dimensional laser scanning device, and the like.

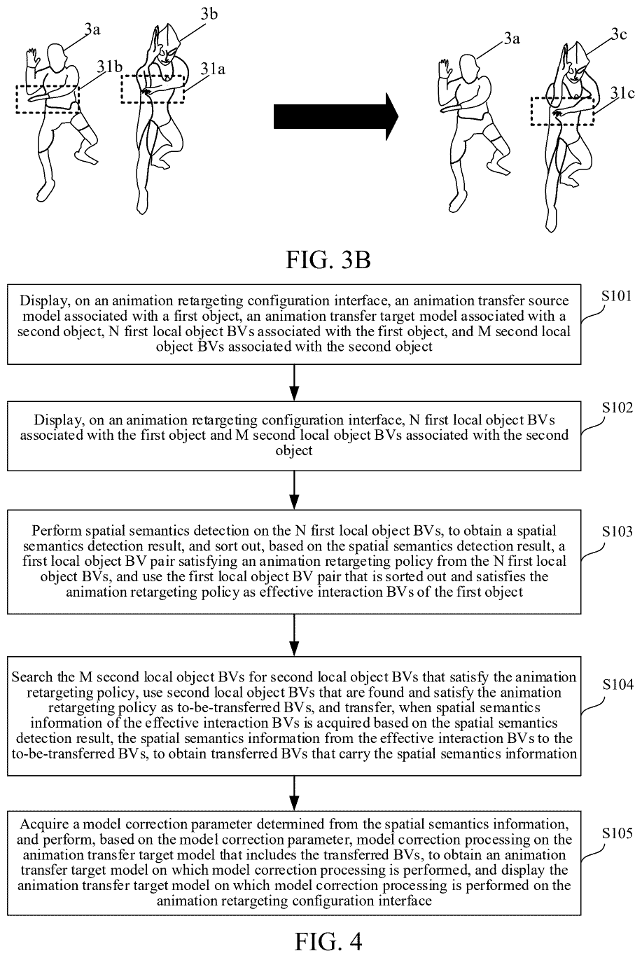

For ease of understanding, refer to FIG. 3A. FIG. 3A is a schematic flowchart of an animation retargeting method according to an embodiment of this disclosure. The animation retargeting method may be performed by the foregoing terminal device 101 or performed by the foregoing server 102. When the animation retargeting solution is executed by the terminal device 101, the terminal device 101 may display a first animation transfer model pair on which spatial semantics transfer is to be performed, and perform spatial semantics detection on a BVH of an animation transfer source model in the first animation transfer model pair, then transfer spatial semantics information obtained through spatial semantics detection to a BVH of an animation transfer target model in the first animation transfer model pair, and perform IK adjustment (that is, model correction) on the animation transfer target model to which the spatial semantics information is transferred, to obtain an animation transfer corrected model (that is, an animation transfer target model on which model correction processing is performed) having spatial semantics information the same as that of the animation transfer source model. The server 102 may be configured to store the first animation transfer model pair, and store a second animation transfer model pair including the animation transfer corrected model and the animation transfer source model. When the animation retargeting solution is executed by the server 102, the server 102 may perform spatial semantics detection on the BVH of the animation transfer source model, then transfer spatial semantics information obtained through spatial semantics detection to the BVH corresponding to the animation transfer target model, and perform IK adjustment (that is, model correction) on the animation transfer target model to which the spatial semantics information is transferred, to obtain an animation transfer corrected model having spatial semantics information the same as that of the animation transfer source model. The terminal device 101 is configured to display, on an animation retargeting configuration interface, the first animation transfer model pair, the second animation transfer model pair including the animation transfer corrected model and the transfer source model, and the like.

For ease of description, the following uses an example in which the animation retargeting method is performed by the terminal device 101, to separately describe performing spatial semantics detection on the BVH of the animation transfer source model, transferring spatial semantics information obtained through spatial semantics detection to the BVH corresponding to the animation transfer target model, and performing IK adjustment on the animation transfer target model to which the spatial semantics information is transferred, to obtain an animation transfer corrected model having spatial semantics information the same as that of the animation transfer source model.

As shown in FIG. 3A, the terminal device 101 may perform the following operation S1 to operation S7, to implement a procedure of the animation retargeting method provided in this embodiment of this disclosure:

Operation S1: The terminal device 101 displays an animation transfer source model associated with a first object.

In this embodiment of this disclosure, the terminal device 101 may first acquire target animation data from the server 102, determine a target frame of animation data in a plurality of frames of animation data included in target animation data, where the target frame of animation data corresponds to the animation transfer source model on which spatial semantics transfer is to be performed and that is associated with the first object, and display, on an animation retargeting configuration interface, the animation transfer source model associated with the first object.

Operation S2: The terminal device 101 displays an animation transfer target model associated with a second object.

The terminal device 101 may select the animation transfer target model associated with the second object and on which spatial semantics transfer is to be performed, and display the animation transfer target model associated with the second object on the animation retargeting configuration interface.

Operation S3: The terminal device 101 constructs a first local object BV set (that is, a first BVH) for the animation transfer source model.

The first local object BV set includes N first local object BVs associated with the first object, where N is a positive integer, and one first local object BV includes one local object of the first object. When the user selects the animation transfer source model associated with the first object from the animation retargeting configuration interface, the terminal device 101 may construct a first initial local object BV set for the animation transfer source model according to a default BV parameter. Because the default BV parameter only adapts to a parameter such as a skeleton length direction, and a radius thereof is usually a default value, all first initial local object BVs in the first initial local object BV set constructed by using the default BV parameter may not be able to include (that is, wrap) one local object. Therefore, in this embodiment of this disclosure, the user may perform fine adjustment on some or all of the first initial local object BVs in the first initial local object BV set, to obtain the first local object BV set corresponding to the animation transfer source model. Through the fine adjustment, the size of the first local object BV in the first local object BV set may be adapted to the scale of the corresponding local object of the first object, thereby properly wrapping the local object.

In this embodiment of this disclosure, constructing the first local object BV set for the animation transfer source model is actually constructing N first local object BVs associated with the first object, and one first local object BV includes one local object of the first object. For example, the first object is an animation character, one first local object BV may include a character limb (for example, a right hand) of the animation character, and another first local object BV may include a left leg of the animation character.

When fine adjustment is performed on the first initial local object BVs, sizes and positions of the first initial local object BVs may be further adjusted according to different interactions between the first initial local object BVs. For example, a first initial local object BV x interacts with a first initial local object BV y. In this case, the positions of the first initial local object BV y and the first initial local object BV x may be adjusted, so that the first initial local object BV y and the first initial local object BV x are in an interactive state.

Operation S4: The terminal device 101 constructs a second local object BV set (that is, a second BVH) for the animation transfer target model.

The second local object BV set includes M second local object BVs associated with the second object, M being a positive integer. One second local object BV includes one local object of the second object. When the user selects the animation transfer target model associated with the second object from the animation retargeting configuration interface, the terminal device 101 may construct a second initial local object BV set for the animation transfer target model according to a default BV parameter. Because the default BV parameter only adapts to a parameter such as a skeleton length direction, and a radius thereof is usually a default value, all second initial local object BVs in the second initial local object BV set constructed by using the default BV parameter may not be able to include a local object of one second object. Therefore, in this embodiment of this disclosure, the user may perform fine adjustment on some or all of the second initial local object BVs in the second initial local object BV set, to obtain the second local object BV set corresponding to the animation transfer target model. Through the fine adjustment, the size of the second local object BV in the second local object BV set may be adapted to the scale of the corresponding local object of the second object, thereby properly wrapping the local object.

In this embodiment of this disclosure, constructing the second local object BV set for the animation transfer target model is actually constructing M second local object BVs associated with the second object, and one second local object BV may include one local object of one second object. For example, the second object is an animation character, and each second local object BV may include a character limb (for example, a right hand, a left leg, or an arm) of the animation character.

When fine adjustment is performed on the second initial local object BVs, sizes and positions of the second initial local object BVs may be further adjusted according to different interactions between the second initial local object BVs. A process of performing fine adjustment on the second initial local object BVs is similar to the process of performing fine adjustment on the first initial local object BVs, and details are not described herein again.

After the first local object BV set and the second local object BV set are constructed in operation S3 and operation S4, a space expression between the animation transfer source model and the animation transfer target model is formed.

Operation S5: The terminal device 101 performs spatial semantics detection on the N first local object BVs in the first local object BV set, to obtain a spatial semantics detection result, and sorts out, based on the spatial semantics detection result, a first local object BV pair satisfying an animation retargeting policy from the N first local object BVs.

In an implementation, the animation retargeting policy includes an interaction detection policy. The interaction detection policy includes an interaction distance threshold for performing interaction detection. In this case, the terminal device may detect closest points between any two first local object BVs in the first local object BV set, and determine, based on a closest point distance between the any two first local object BVs, two first local object BVs corresponding to a closest point distance less than the interaction distance threshold in the N first local object BVs. The two first local object BVs are the first local object BV pair.

In some embodiments, the terminal device may use the first local object BV pair as the effective interaction BVs of the first object.

Operation S6: The terminal device 101 performs spatial semantics transfer.

That is, the terminal device 101 acquires the spatial semantics information of the effective interaction BVs on which spatial semantics detection is performed, and transfers the spatial semantics information of the effective interaction BV to the corresponding second local object BV in the animation transfer target model, to obtain transferred BVs carrying the spatial semantics information.

The spatial semantics information of the effective interaction BV may be configured for indicating a spatial relationship between two first local object BVs in the first local object BV pair. Therefore, the spatial semantics information of the effective interaction BV may be configured for constraining a spatial relationship between corresponding second local object BVs on the animation transfer target model in an animation retargeting adjustment process. Because sizes and orientations of the first local object BV and the second local object BV may be different, it is required that during transfer of the spatial semantics information of the effective interaction BV obtained in the spatial semantics detection operation, shapes, sizes, and orientations of the animation transfer source model and the animation transfer target model need to be invariant. Therefore, the spatial semantics information of the effective interaction BV obtained in the spatial semantics detection operation needs to be transferred to a corresponding second local object BV in the second local object BV set, that is, in a spatial semantics transfer process, is to be properly transferred to the same semantics position of the corresponding second local object BV. For example, spatial semantics information of an effective interaction BV includes an inner forearm midpoint. Therefore, in the M second local object BVs, a second local object BV including a forearm can be correctly positioned, and an inner forearm midpoint in the second local object BV is further positioned.

In some embodiments, after performing spatial semantics transfer, to keep a spatial relationship of the animation transfer target model including the transferred BVs consistent with a spatial relationship of the animation transfer source model, the terminal device 101 may further perform the following operation S7.

Operation S7: The terminal device 101 performs model correction on the animation transfer target model including the transferred BVs, to obtain an animation transfer corrected model.

In this embodiment of this disclosure, after the animation transfer corrected model is obtained, the animation transfer corrected model and the animation transfer source model may be displayed on the animation retargeting configuration interface. For example, an EEF may be determined from the animation transfer target model including the transferred BVs. The EEF usually corresponds to a joint chain related to the second object. The joint chain in which the EEF is located may be changed by adjusting a position of the EEF. For example, if the EEF is a hand or a foot, the hand or the foot may be adjusted to cause a corresponding change process conforming to a constraint to the remaining upstream joint, thereby obtaining the animation transfer corrected model, and then keeping a spatial relationship of the animation transfer corrected model consistent with a spatial relationship of the animation transfer source model.

For ease of understanding, refer to FIG. 3B. FIG. 3B is a schematic diagram of model correction according to an embodiment of this disclosure. In FIG. 3B, a left hand of an animation transfer source model 3a keeps a particular distance from a right elbow (that is, as shown by 31b in FIG. 3B), and a left hand of an animation transfer target model 3b including transferred BVs and on which spatial semantics transfer is performed is excessively close to a right elbow (that is, as shown by 31a in FIG. 3B). In this case, to keep a spatial relationship between BVs on the animation transfer target model including the transferred BVs consistent with a spatial relationship between those on the animation transfer source model, a distance between the left hand and the right elbow is increased by adjusting an EEF (for example, the left hand), thereby performing model correction on the animation transfer target model including the transferred BVs, to obtain an animation transfer corrected model 3c. In this case, a left hand and a right elbow of the animation transfer corrected model are consistent (that is, as shown by 31c in FIG. 3B), and a spatial relationship is improved, thereby improving an animation retargeting effect.

For an implementation process in which the terminal device 101 performs spatial semantics detection on the first local object BV set, performs spatial semantics transfer based on a spatial semantics detection result, and performs model correction on the animation transfer target model including the transferred BVs, refer to descriptions of embodiments corresponding to FIG. 4 to FIG. 22.

FIG. 4 is a schematic flowchart of an animation retargeting method according to an embodiment of this disclosure. The animation retargeting method may be performed by a computer device, and the computer device may be the terminal device 101 or the server 102 in the foregoing animation retargeting system. For ease of understanding, an example in which the computer device is the terminal device 101 is used to describe the animation retargeting method provided in this embodiment of this disclosure. In the embodiments of this disclosure, the animation retargeting method may include at least the following operation S101 to operation S105:

Operation S101: Display, on an animation retargeting configuration interface, an animation transfer source model associated with a first object, an animation transfer target model associated with a second object, N first local object BVs associated with the first object, and M second local object BVs associated with the second object.

N and M are both positive integers; one first local object BV including one local object of the first object; and One second local object BV includes one local object of the second object.

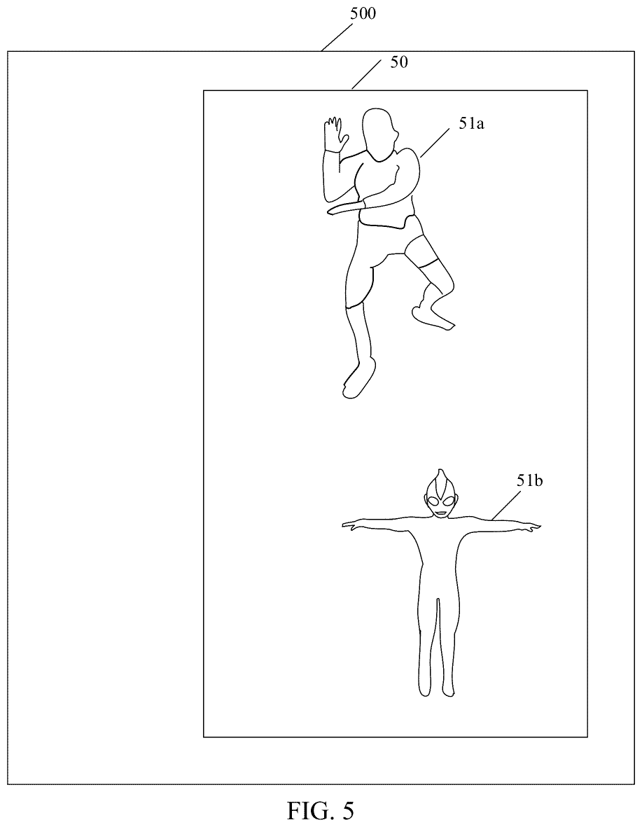

The animation transfer source model associated with the first object and the animation transfer target model associated with the second object may be referred to as a first animation transfer model pair on which spatial semantics transfer is to be performed. The first object and the second object may be game characters, social characters, animals, or the like. The first animation transfer model pair may be displayed in any area on the animation retargeting configuration interface (for example, a middle area or a right area of the animation retargeting configuration interface). This is not limited in this embodiment of this disclosure. For example, FIG. 5 is a schematic diagram of displaying a first animation transfer model pair on an animation retargeting configuration interface according to an embodiment of this disclosure. In FIG. 5, a first animation transfer model pair may be displayed in an area 50 of an animation retargeting configuration interface 500. The first animation transfer model pair includes an animation transfer source model 51a associated with a first object and an animation transfer target model 51b associated with a second object.

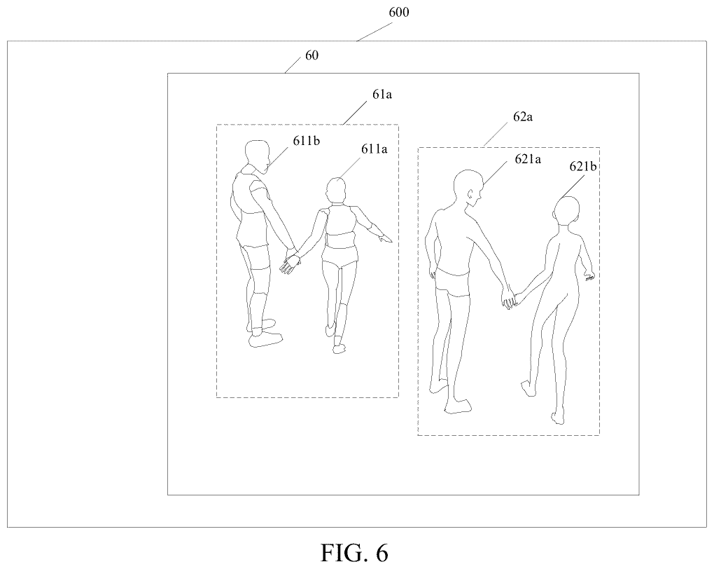

The first object may include L first sub-objects, and the animation transfer source model associated with the first object includes an animation transfer source sub-model associated with each first sub-object. Similarly, the second object may include L second sub-objects, and the animation transfer target model associated with the second object includes an animation transfer target sub-model associated with each second sub-object, where L is a positive integer. When Lis 1, the first sub-object included in the first object is the first object itself, and the second sub-object included in the second object is the second object itself. When L is greater than or equal to 2, the first animation transfer model pair includes L animation transfer sub-model pairs, that is, one animation transfer sub-model pair includes one animation transfer source sub-model associated with a first sub-object and one animation transfer target sub-model associated with a second sub-object. For ease of understanding, refer to FIG. 6. FIG. 6 is another schematic diagram of displaying a first animation transfer model pair on an animation retargeting configuration interface according to an embodiment of this disclosure. In FIG. 6, an animation transfer source model 61a associated with a first object and an animation transfer target model 62a associated with a second object are displayed in an area 60 of an animation retargeting configuration interface 600. The first object includes two first sub-objects, that is, a first sub-object A and a second sub-object B. In this case, the animation transfer source model 61a associated with the first object includes an animation transfer source sub-model 611a associated with the first sub-object A and an animation transfer source sub-model 611b associated with the first sub-object B. The second object includes two second sub-objects, that is, a second sub-object C and a second sub-object D. In this case, the animation transfer target model 62a associated with the second object includes an animation transfer target sub-model 621a associated with the second sub-object C and an animation transfer target sub-model 621b associated with the second sub-object D. Then, the first animation transfer model pair may include two animation transfer sub-model pairs, that is, one animation transfer sub-model pair may include the animation transfer source sub-model 611a associated with the first sub-object A and the animation transfer target sub-model 621a associated with the second sub-object C; and the other animation transfer sub-model pair may include the animation transfer source sub-model 611b associated with the first sub-object B and the animation transfer target sub-model 621b associated with the second sub-object D.

In this embodiment of this disclosure, a local object of the first object may be determined according to the first object. For example, the first object is a game character, and the local object of the first object may include but is not limited to: a head, a left hand, a right hand, a left foot, a right foot, a left lower arm, a right lower arm, or the like. For another example, the first object is an animal, and the local object of the first object may include but is not limited to: a head, a left palm, a right palm, or the like. Similarly, a local object of the second object may be determined according to the second object. For example, the first object is a game character, and the local object of the second object may include but is not limited to: a head, a left hand, a right hand, a left foot, a right foot, a left lower arm, a right lower arm, or the like.

The first geometry attribute of the first local object BV may be a sphere attribute, a capsule attribute, a cube attribute, or the like. Correspondingly, the first local object BV corresponding to the first geometry attribute is a sphere, a capsule, a cube, or the like. The second geometry attribute of the second local object BV may also be a sphere attribute, a capsule attribute, a cube attribute, or the like. Correspondingly, the second local object BV corresponding to the second geometry attribute is a sphere, a capsule, a cube, or the like. The first geometry attribute and the second geometry attribute may be the same, or may be different. This is not limited in this embodiment of this disclosure.

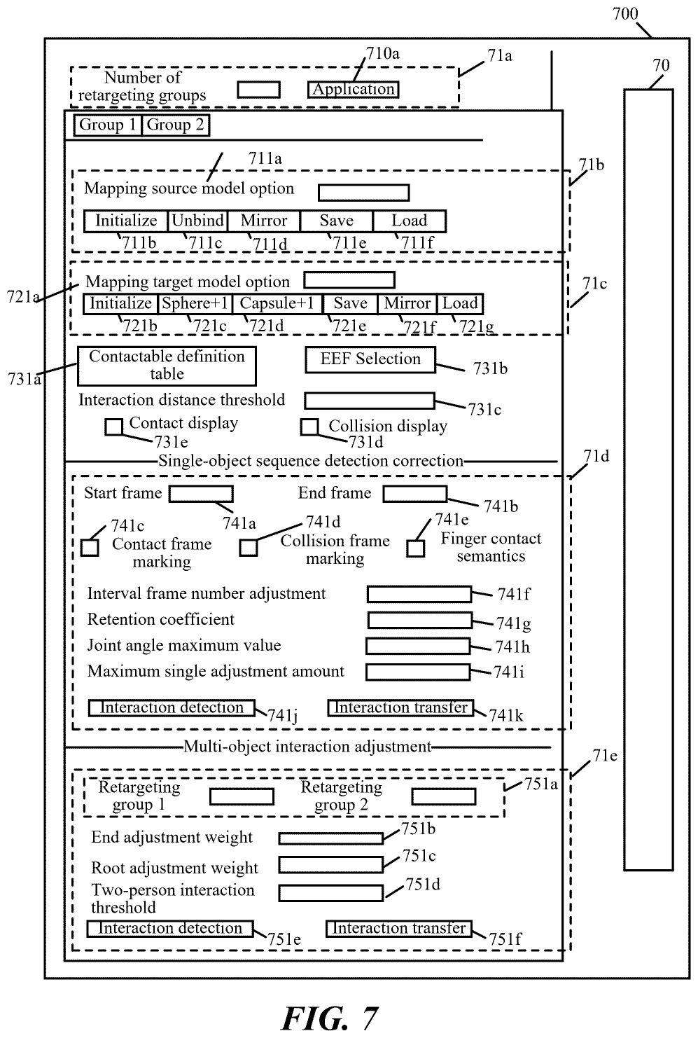

In the embodiments of this disclosure, a BVH may be configured for each of the animation transfer source model and the animation transfer target model that are displayed on the animation retargeting configuration interface, and operations such as adjustment, loading, and saving may be performed on a BV in the BVH configured for each of the animation transfer source model and the animation transfer target model. For ease of understanding, refer to FIG. 7. FIG. 7 is a schematic diagram of an animation retargeting configuration interface according to an embodiment of this disclosure. The number of animation retargeting groups may be set by using the animation retargeting configuration interface, and a BVH is constructed for each of an animation transfer source model and an animation transfer target model that are displayed. In FIG. 7, the animation retargeting configuration interface 700 includes a model pair display area 70 and an animation retargeting setting area 71a. The model pair display area 70 may be the area 50 in FIG. 5 or the area 60 in FIG. 6. This is not limited in this embodiment of this disclosure. The animation retargeting setting area 71a is configured to set the number of groups on which animation retargeting needs to be performed in a scenario. The number of groups for animation retargeting herein may be set according to a requirement. For example, the number of groups for animation retargeting is 1, 2, or the like. In this embodiment of this disclosure, the animation transfer source model associated with the first object and the animation transfer target model associated with the second object may be referred to as a retargeting group. When the first object includes L first sub-objects, and the second object includes L second sub-objects, that is, the first animation transfer sub-model pair includes L animation transfer sub-model pairs, the number of groups for animation retargeting is L. In some embodiments, the animation orientation setting area may include an application option 710a. The user may trigger (for example, tapping or double-tapping) the application option 710a. Correspondingly, the terminal device 101 may generate, in response to a trigger operation on the application option 710a, one or more animation retargeting groups (that is, Retarget or) satisfying the number of animation retargeting groups according to the number of animation retargeting groups.

The animation retargeting configuration interface may further include an animation transfer source model option 711a and an animation transfer target model option 721a. In this case, before the first animation transfer model pair on which spatial semantics transfer is to be performed is displayed on the animation retargeting configuration interface, the user may trigger the animation transfer source model option 711a, and then the terminal device 101 may display a plurality of frames of animation data in response to a trigger operation on the animation transfer source model option 711a, where each frame of animation data includes the animation transfer source model associated with the first object, and determine a target frame of animation data in the plurality of frames of animation data, where the target frame of animation data corresponds to the animation transfer source model associated with the first object. Similarly, the user may trigger the animation transfer target model option 721a, and then the terminal device 101 may select the animation transfer target model from an animation transfer target model library in response to the trigger operation on the animation transfer target model option.

The animation retargeting configuration interface may further include an animation transfer source model configuration area 71b and an animation transfer target model configuration area 71c. The animation transfer source model option 711a is located in the animation transfer source model configuration area 71b, and the animation transfer target model option 721a is located in the animation transfer target model configuration area 71c. The animation transfer source model configuration area 71b includes a first BV initialization option 711b, an unbinding option 711c, a first mirroring option 711d, a first saving option 711e, and a first loading option 711f.

The first BV initialization option 711b may be configured for initializing a local object BV of the animation transfer source model, to obtain N first initial local object BVs associated with the first object. The unbinding option 711c is configured for unbinding the animation transfer source model from the N first initial local object BVs. The first mirroring option 711d is configured for transferring, when the first object has symmetrical limbs (that is, symmetrical local objects), parameter information of a first local object BV edited on one side of one limb of the symmetrical limbs to a first local object BV of the other limb symmetrical to the one limb. For example, left and right arms of the first object are symmetric limbs. After the first initial local object BV including the left arm is completely edited to obtain the first local object BV including the left arm, the parameter information of the first local object BV may be directly transferred to the first initial local object BV including the right arm through the first mirroring option, to obtain the first local object BV including the right arm. The N first local object BVs associated with the first object may be quickly constructed through the first mirroring option. The first saving option 711e is configured for saving a configuration file corresponding to the N first local object BVs associated with the first object. The first loading option 711f is configured for loading the saved configuration file of the N first local object BVs associated with the first object.

In this embodiment of this disclosure, the displaying, on an animation retargeting configuration interface, N first local object BVs associated with the first object may be: displaying, in response to a trigger operation on the first BV initialization option, N first initial local object BVs associated with the first object; then unbinding the N first initial local object BVs from the animation transfer source model, to obtain unbound N first initial local object BVs; and adjusting, in response to an adjustment operation on the unbound N first initial local object BVs, the unbound N first initial local object BVs to obtain the N first local object BVs associated with the first object, and displaying the N first local object BVs associated with the first object on the animation retargeting configuration interface.

Before the N first initial local object BVs are edited, the N first initial local object BVs need to be unbound from the animation transfer source model. However, when the M second initial local object BVs are edited, the M second initial local object BVs do not need to be unbound from the animation transfer target model.

In this embodiment of this disclosure, the unbinding the N first initial local object BVs from the animation transfer source model, to obtain unbound N first initial local object BVs may be: unbinding, in response to a trigger operation (for example, a tap operation, a double-tap operation, or an interactive operation) on the unbinding option 711c, the N first initial local object BVs from the animation transfer source model, to obtain unbound N first initial local object BVs.

In some embodiments, the animation transfer target model configuration area 71c may further include a second BV initialization option 721b, a first geometry attribute BV addition option 721c, a second geometry attribute BV addition option 721d, a second mirroring option 721e, a second saving option 721f, and a second loading option 721g. The second BV initialization option 721b may be configured for initializing a local object BV of the animation transfer target model to obtain M initial second local object BVs associated with the second object. The first geometry attribute BV addition option 721c is configured for adding one first geometry attribute BV to the scenario, to wrap an additional moving object. The second geometry attribute BV addition option 721d is configured for adding one second geometry attribute BV to the scenario, to wrap an additional moving object. The moving object herein may be determined according to different scenarios. For example, the scenario is a game scenario, and the moving object may include, but is not limited to: game equipment or social equipment. The game equipment may be, for example, a packsack or an armor. The social equipment may be, for example, a fluorescent stick. The second mirroring option 721e is configured for transferring, when the second object has symmetrical limbs (that is, symmetrical local objects), parameter information of a second local object BV edited on one side of one limb of the symmetrical limbs to a second local object BV of the other limb symmetrical to the one limb. The second saving option 721f is configured for saving a configuration file corresponding to the M second local object BVs associated with the second object. The second loading option 721g is configured for loading the saved configuration file of the M second local object BVs associated with the second object.

In this embodiment of this disclosure, the displaying, on an animation retargeting configuration interface, M second local object BVs associated with the second object may include: displaying, in response to a trigger operation on the second BV initialization option, M second initial local object BVs associated with the second object; and adjusting, in response to an adjustment operation on the M second initial local object BVs, the M second initial local object BVs to obtain the M second local object BVs associated with the second object, and displaying the M second local object BVs associated with the second object on the animation retargeting configuration interface.

The first local object BV and the second local object BV may be spheres, capsules, cubes, cuboids, or the like. The adjustment operation in this embodiment of this disclosure may include one or more of the following: a moving operation, a scaling operation, and a rotating operation. In this embodiment of this disclosure, the adjustment operation may be performed on some or all first initial local object BVs of the N first initial local object BVs, or the adjustment operation may be performed on some or all second initial local object BVs of the M second initial local object BVs. The first local object BVs or the second local object BVs obtained through the adjustment operation can more properly wrap corresponding local objects.

In the embodiments of this disclosure, the first local object BV, the second local object BV, and the BV additionally wrapping the moving object are established, and adjustment to the first local object BV and the second local object BV is introduced, so that a BV wraps a local object of an object more properly, and a rigid object such as a packsack, an armor, or a helmet on a limb may be correctly wrapped. Even a BV of a battle tool may be introduced according to a requirement, to endow interaction retargeting of the battle tool, thereby greatly improving an adaptability to various complex models, and resolving, when a complex model is processed, that a universal hull mesh thereof cannot be correctly generated on the complex model, so that the processing effect of including an armor or a complex character model may be improved.

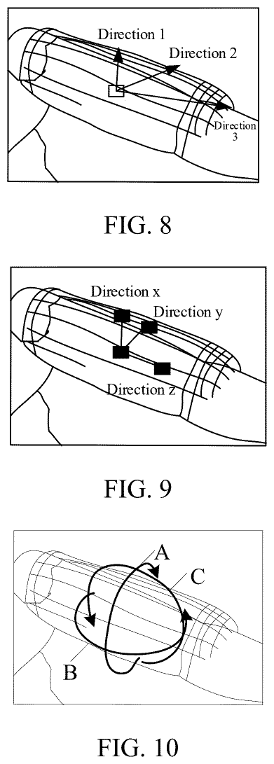

In this embodiment of this disclosure, the moving operations may be moving operations in different directions. For example, FIG. 8 is a schematic diagram of a moving operation according to an embodiment of this disclosure. FIG. 8 schematically shows that a first initial local object BV or a second initial local object BV may be moved from three directions (namely, a direction 1, a direction 2, and a direction 3). When the adjustment operation is a moving operation, the first initial local object BV may be moved in a direction indicated by the moving operation in response to the moving operation on the first initial local object BV.

The scaling operation may be scaling up or scaling down the first initial local object BV or the second initial local object BV in different directions, to adjust the size of the first initial local object BV. For example, FIG. 9 is a schematic diagram of a scaling operation according to an embodiment of this disclosure. FIG. 9 schematically shows that a first initial local object BV or a second initial local object BV is scaled from three directions (namely, a direction x, a direction y, and a direction z). When the adjustment operation is a first scaling operation, the first initial local object BV may be scaled up in a direction indicated by the scaling operation in response to the first scaling operation on the first initial local object BV. When the adjustment operation is a second scaling operation, the first initial local object BV may be scaled down in a direction indicated by the scaling operation in response to the second scaling operation on the first initial local object BV.

The rotating operation may be adjusting the position of the first initial local object BV or the second initial local object BV along different directions. For example, FIG. 10 is a schematic diagram of a rotating operation according to an embodiment of this disclosure. FIG. 10 schematically shows that a first initial local object BV or a second initial local object BV is rotated from three directions (namely, a direction A, a direction B, and a direction C). When the adjustment operation is a rotating operation, the first initial local object BV may be rotated in a direction indicated by the rotating operation in response to the rotating operation on the first initial local object BV.

In some embodiments, the animation retargeting configuration interface may further include a selection contact list option 731a. A contactable definition table may be configured for the animation transfer source model by triggering the selection contact list option. The contactable definition table may be configured for defining a probability of contact between different first local object BVs in the animation transfer source model. For example, the probability of contact may be indicated by using 0/1. When a probability of contact between any two first local object BVs is 0, it indicates that a contact relationship between the two first local object BVs is no contact. When a probability of contact between any two first local object BVs is 1, it indicates that the two first local object BVs may be in contact. For example, as shown in Table 1, Table 1 shows probabilities of contact between some first local object BVs in the animation transfer source model:

TABLE 1

| | | | BV of the | BV of the |
|---|---|---|---|---|
| | BV of the | BV of the | right lower | left lower |
| BV | right hand | left hand | arm | arm |
| BV of the right hand | 0 | 1 | 0 | 1 |
| BV of the left hand | 1 | 0 | 1 | 0 |
| BV of the right lower | 0 | 1 | 0 | 1 |
| arm | | | | |
| BV of the left lower | 1 | 0 | 1 | 0 |
| arm | | | | |

It may be learned from Table 1 that a probability of contact between the BV of the right hand (that is, the first local object BV including the right hand) and the BV of the right hand (that is, the first local object BV including the right hand) is no contact; a probability of contact between the BV of the left hand (that is, the first local object BV including the left hand) and the BV of the right hand (that is, the first local object BV including the right hand) is possible contact; and by analogy, a contact relationship between all first local object BVs in the animation transfer source model may be defined in the contactable definition table. Configuring a contactable definition table for the animation transfer source model may be used to save a particular calculation amount when spatial semantics detection is subsequently performed. That is, spatial semantics detection may be subsequently performed on first local object BVs that may be in contact.

When the first object includes L first sub-objects, it means that a probability of contact between first local object BVs exists between first sub-objects. In this case, a contact probability between first local object BVs in an animation transfer source sub-model associated with a first sub-object may be defined in the contactable definition table, and a contact probability between first local object BVs in different animation transfer source sub-models may be further defined in the contactable definition table. For example, the first object includes two first sub-objects (that is, a first sub-object 1 and a first sub-object 2). In this case, a contact probability between first local object BVs in an animation transfer source sub-model 1 associated with the first sub-object 1 may be defined in the contactable definition table. A contact probability between first local object BVs in two animation transfer source sub-models (that is, the animation transfer source sub-model 1 associated with the first sub-object 1 and an animation transfer source sub-model 2 associated with the first sub-object 2) may be further defined in the contactable definition table.

A contactable definition table may be further configured for the animation transfer target model by triggering a selection contact table key. In this case, the contactable definition table may be configured for defining a contact probability between different second local object BVs in the animation transfer target model. Certainly, the contactable definition table configured for the animation transfer source model and the contactable definition table configured for the animation transfer target model may be one table. That is, one contactable definition table may include a probability of contact between first local object BVs, and may also include a probability of contact between second local object BVs. Alternatively, the contactable definition table configured for the animation transfer source model and the contactable definition table configured for the animation transfer target model may be two different tables.

In some embodiments, the animation retargeting configuration interface may further include an EEF configuration option 731b. By triggering the EEF configuration option 731b, a first local object BV used as an EEF may be selected from the N first local object BVs associated with the first object, and a model may be corrected by setting the EEF. The user may trigger the EEF configuration option 731b, and then the terminal device 101 may display the N first local object BVs in response to a trigger operation on the EEF configuration option 731b, and select a first local object BV used as an EEF from the N first local object BVs.

A second local object BV as an EEF may be further selected from the M second local object BVs associated with the second object by using the EEF configuration option.

In some embodiments, the animation retargeting configuration interface may further include a first interaction distance threshold setting area 731c. The first interaction distance threshold setting area 731c is configured for setting a first interaction distance threshold configured for performing interaction detection. The first interaction distance threshold may be configured for determining whether effective interaction exists between the first local object BVs associated with the first object. In addition, the animation retargeting configuration interface may further include a contact display key 731e and a collision display key 731d. Whether to highlight the first local object BV and the second local object BV that are in contact in the scenario may be selected by using the display contact key 731e. Whether to highlight the first local object BV in collision in the scenario and whether to highlight the second local object BV in collision in the scenario may be selected by using the collision display key 731d.

The highlighting manner is not limited in this embodiment of this disclosure. In an implementation, by using the display contact key, a choice of displaying the first local object BVs that are in contact in different colors in the scenario is made. Therefore, when a contact probability exists between a first local object BV S1 and a first local object BV S2, the first local object BV S1 and the first local object BV S2 that may be in contact may be displayed in red. However, for other first local object BVs that are not in contact, the first local object BVs that are not in contact are displayed in black. In another implementation, by using the display contact key 731e, a choice of displaying the first local object BVs that may be in contact in bold in the scenario may be made. Therefore, when a contact probability exists between a first local object BV S1 and a first local object BV S2, the first local object BV S1 and the first local object BV S2 that may be in contact may be displayed in bold. However, other first local object BVs that are not in contact do not need to be in bold.

The animation transfer source model is a model of one frame of animation data selected from a plurality of frames of animation data, and the plurality of frames of animation data constitute an action sequence of the first object. In this case, when each frame of animation data in the transfer model is transferred to the animation transfer target model, an action sequence of the second object may be constituted similarly. In this case, the animation retargeting configuration interface may further include a single-object sequence detection correction area 71d. The single-object sequence detection correction area 71d is configured for detecting, transferring, and correcting the action sequence (that is, presented by using the animation transfer source model) of the first object. The detection refers to performing spatial semantics detection on the N first local object BVs associated with the first object. The transfer refers to transferring spatial semantics information obtained by performing spatial semantics detection on the N first local object BVs to the animation transfer target model. The correction refers to performing model correction on the animation transfer target model obtained through transfer after the spatial semantics information is transferred to the animation transfer target model.

The single-object sequence detection correction area 71d may include a start frame setting option 741a and an end frame setting option 741b. A range of frames that need to be detected and corrected may be defined by using the start frame setting option 741a and the end frame setting option 741b. For example, if the target animation data includes ten frames of animation data, the start frame may be the first frame, and the end frame is the seventh frame, which means that animation data from the first frame to the seventh frame may be detected, transferred, and corrected. In some embodiments, the single-object sequence detection correction area may further include a contact frame marking option 741c and a collision frame marking option 741d. Whether to highlight a frame in which contact exists may be set by using the contact frame marking option 741c, and whether to highlight a frame in which collision exists may be set by using the collision frame marking option 741d. The frame in which contact exists means that there is contact between the first local object BVs in the animation transfer source model corresponding to the frame of animation data. The frame in which collision exists means that there is a collision between the first local object BVs in the animation transfer source model corresponding to the frame of animation data. The highlighting may be marking in different colors, marking by using text, or the like.

In some embodiments, the single-object sequence detection correction region 71d may further include a finger contact semantics option 741e. By using the finger contact semantics option 741e, whether finger contact semantics is included needs to be considered when the spatial semantics detection is performed on the N first local object BVs in the animation transfer source model may be set. For example, the single-object sequence detection correction area 71d may further include an interval frame number adjustment setting option 741f. The interval frame number adjustment setting option 741f is configured for configuring a frame number ratio (that is, may be understood as a frame sampling ratio) for performing spatial semantics detection, transfer, and model correction. The frame number ratio may be, for example, 0.4 or 0.5. For example, after the start frame and the end frame are set, frames between the start frame and the end frame may be sampled according to the frame number ratio, and spatial semantics detection, transfer, and model correction are performed on the animation transfer source model corresponding to the sampled frames.

In some embodiments, the single-object sequence detection correction area 71d may further include a retention coefficient configuration option 741g. The retention coefficient configuration option 741g is configured for configuring a weight coefficient for retaining a current position of the animation transfer target model. A larger retention coefficient indicates a smaller adjustment to the current position of the animation transfer target model. In addition, the single-object sequence detection correction area 71d may further include a joint angle maximum difference setting option 741h. The joint angle maximum difference setting option 741h may be configured for setting, in a process of performing model correction on the animation transfer target model including the transferred BVs, a joint angle maximum difference by which a joint of the second object in the animation transfer target model including the transferred BVs can be adjusted. In a model correction processing process, if an adjustment needs to make a joint angle of a joint greater than the set joint angle maximum difference, the adjustment is not performed.

In some embodiments, the single-object sequence detection correction area 71d may further include a maximum single adjustment amount setting area 741i. The maximum single adjustment amount setting area 741i is configured for setting, in a model correction process, an upper limit of a distance by which a joint corresponding to the second object can be adjusted (for example, the distance by which the joint corresponding to the second object can be adjusted each time is 5 cm). Alternatively, the single-object sequence detection correction region 71d may further include a first interaction detection key 741j and a first interaction transferring key 741k. Spatial semantics detection may be performed on the N first local object BVs associated with the first object by using the first interaction detection key 741j. The spatial semantics information in the N first local object BVs may be transferred to the animation transfer target model by using the first interaction transfer key 741k, and correspondingly corrected.

When the first object includes L first sub-objects, and the second object includes L second sub-objects, L is a positive integer greater than 1. In this case, an action scenario of multi-object interaction exists. For example, a case that Lis 2 indicates a two-object interaction scenario. For the action scenario of multi-object interaction, in this embodiment of this disclosure, a multi-object interaction adjustment area 71e is provided on the animation retargeting configuration interface. As shown in FIG. 7, the multi-object interaction adjustment area 71e includes a retargeting setting group selection area 751a. A plurality of retargeting groups may be selected in the retargeting setting group selection area 751a, to correspond to a plurality of retargeting mappings in the scenario. For example, if L is 2, two retargeting groups may be selected in the retargeting setting group selection area 751a, to correspond to two retargeting mappings in the scenario.

In a multi-object interaction scenario, a model corresponding to a plurality of objects is corrected (that is, in this embodiment of this disclosure, the second object includes L second sub-objects, and in this case, model correction is performed on an animation transfer target sub-model associated with each second sub-object of the L second sub-objects). In this case, global root coordinates corresponding to the animation transfer target sub-model associated with each second sub-object need to be adjusted. The root coordinates are coordinates of the animation transfer target sub-model. In this case, the animation retargeting configuration interface further includes an end adjustment weight configuration area 751b and a root adjustment weight configuration area 751c. The end adjustment weight configuration area 751b is configured for configuring an end adjustment weight of an animation transfer target sub-model. The end adjustment weight refers to an adjustment weight required, when model correction is performed on an animation transfer target sub-model, in a case that a BV in the animation transfer target sub-model as an EEF reaches an end position. The root adjustment weight configuration area 751c is configured for configuring a root adjustment weight of an animation transfer target sub-model. The root adjustment weight refers to an adjustment weight required, when model correction is performed on an animation transfer target sub-model, by the animation transfer target sub-model in a case that a BV as an EEF needs to reach an end position (that is, a target position). In short, in a multi-object interaction scenario, because there is interaction between different animation transfer source sub-models, after the spatial semantics information is transferred to different animation transfer target sub-models, for example, when a position of a BV including a hand of a second sub-object is adjusted, not only an end adjustment weight of the BV including the hand of the second sub-object needs to be configured, but also interaction between different animation transfer target sub-models needs to be considered. Therefore, a root adjustment weight needed when an entire animation transfer target sub-model is moved needs to be further configured. The accuracy of model correction may be implemented by using the end adjustment weight and the root adjustment weight.

In some embodiments, the animation retargeting configuration interface may further include an interaction distance threshold setting area 751d. The interaction distance threshold setting area 751d is configured for setting a second interaction distance threshold configured for performing interaction detection. The second interaction distance threshold is configured for determining whether effective interaction exists between first local object BVs associated with different first sub-objects. The multi-object interaction adjustment region 71e may further include a second interaction detection key 751e and a second interaction transferring key 751f. Spatial semantics detection may be performed on the N first local object BVs associated with the first object by using the second interaction detection key 751e. The second interaction transfer key may be configured to transfer spatial semantics information between the N first local object BVs to the animation transfer target model, and corresponding model correction is performed, so that spatial semantics is retained.

Operation S102: Perform spatial semantics detection on the N first local object BVs, to obtain a spatial semantics detection result, and sort out, based on the spatial semantics detection result, a first local object BV pair satisfying an animation retargeting policy from the N first local object BVs, and use the first local object BV pair that is sorted out and satisfies the animation retargeting policy as effective interaction BVs of the first object.

In response to a spatial semantics detection trigger operation on the N first local object BVs, spatial semantics detection may be performed on the N first local object BVs to obtain a spatial semantics detection result. The spatial semantics detection result may include a closest point pair and a closest point distance between any two first local object BVs of the N first local object BVs. The spatial semantics detection trigger operation may be a trigger operation on the first interaction detection key or a trigger operation on the second interaction detection key. The trigger operation may be, for example, tapping or double-tapping. The effective interaction BVs include the first local object BVs.

The animation retargeting policy includes an interaction detection policy and an interaction transfer policy. The interaction detection policy is configured for sorting out the first local object BV pair from the N first local object BVs, and the interaction transfer policy is configured for performing interaction transfer (that is, spatial semantics transfer). The interaction detection policy may include an interaction distance threshold configured for performing interaction detection. In this case, the N first local object BVs include a first local object BV i and a first local object BV j, where i is not equal to j, and i and j are both positive integers less than or equal to N.

The sorting out a first local object BV pair from the N first local object BVs based on the spatial semantics detection result between the first local object BV i and the first local object BV j may include: acquiring, based on the spatial semantics detection result, the first local object BV i and the first local object BV j from the N first local object BVs, and determining the first closest point distance between the first local object BVᵢ and the first local object BV j; and using, if the first closest point distance between the first local object BVᵢ and the first local object BV j is less than the interaction distance threshold, the first local object BV i and the first local object BV j as the first local object BV pair that is sorted out from the N first local object BVs and satisfies the animation retargeting policy.

The interaction distance threshold may include a first interaction distance threshold and a second interaction distance threshold. When the first object includes no first sub-object, the interaction distance threshold includes the first interaction distance threshold. When the first object includes L first sub-objects, the interaction distance threshold includes the first interaction distance threshold and the second interaction distance threshold. The first interaction distance threshold may be configured for determining whether effective interaction exists between first local object BVs associated with a first sub-object. The second interaction distance threshold is configured for determining whether effective interaction exists between first local object BVs associated with different first sub-objects.

When the spatial semantics detection trigger operation is a trigger operation on the first interaction detection key, the interaction distance threshold may include the first interaction distance threshold. When the spatial semantics detection trigger operation is a trigger operation on the second interaction detection key, the interaction distance threshold may include the first interaction distance threshold and the second interaction distance threshold.

Operation S103: Search the M second local object BVs for second local object BVs that satisfy the animation retargeting policy, use second local object BVs that are found and satisfy the animation retargeting policy as to-be-transferred BVs, and transfer, when spatial semantics information of the effective interaction BVs is acquired based on the spatial semantics detection result, the spatial semantics information from the effective interaction BVs to the to-be-transferred BVs, to obtain transferred BVs that carry the spatial semantics information.

The spatial semantics information is configured for describing a spatial relationship between the effective interaction BVs. The spatial semantics information of the effective interaction BVs may be configured for constraining a spatial relationship between to-be-transferred BVs with the same local object attribute in the animation transfer target model in a retargeting adjustment process.

In response to an interaction transfer operation, the M second local object BVs may be searched for second local object BVs that satisfy the animation retargeting policy. The interaction transfer operation may be at least one of a trigger operation on the first interaction transfer key and a trigger operation on the second interaction transfer option.

The animation retargeting policy includes an interaction transfer policy, and the interaction transfer policy includes local object attributes of the effective interaction BVs. The searching the M second local object BVs for second local object BVs that satisfy the animation retargeting policy may be: searching the M second local object BVs for second local object BVs having local object attributes the same as those of the effective interaction BVs, and determining the second local object BVs having the local object attributes the same as those of the effective interaction BVs as the second local object BVs satisfying the animation retargeting policy. In the embodiments of this disclosure, the effective interaction BVs may include a first effective interaction BV and a second effective interaction BV. In this case, the searching the M second local object BVs for second local object BVs having local object attributes the same as those of the effective interaction BVs may include: searching the M second local object BVs for a second local object BV having a local object attribute the same as that of the first effective interaction BV to serve as the first to-be-transferred BV corresponding to the first effective interaction BV, and searching the M second local object BVs for a second local object BV having a local object attribute the same as that of the second effective interaction BV to serve as the second to-be-transferred BV corresponding to the second effective interaction BV.

In this embodiment of this disclosure, the second object includes L second sub-objects, and the M second local object BVs include second local object BVs associated with the L second sub-objects. In this case, an animation transfer source sub-model corresponding to an effective interaction BV is determined first, an animation transfer target sub-model having an animation retargeting relationship with the animation transfer source sub-model is determined according to a plurality of retargeting groups configured in the retargeting setting group selection area 751a, and the animation transfer target sub-model having the animation retargeting relationship with the animation transfer source sub-model is searched for the second local object BV having the same local object attribute as that of the effective interaction BV. The local object attribute may be, for example, left hand or right hand.

Operation S104: Acquire a model correction parameter determined from the spatial semantics information, and perform, based on the model correction parameter, model correction processing on the animation transfer target model that includes the transferred BVs, to obtain an animation transfer target model on which model correction processing is performed, and display the animation transfer target model on which model correction processing is performed on the animation retargeting configuration interface. Spatial semantics information of the animation transfer target model on which model correction processing is performed is kept consistent with spatial semantics information of the animation transfer source model.

In this embodiment of this disclosure, the animation transfer target model on which model correction processing is performed may be used as an animation transfer corrected model, and the animation transfer corrected model and the animation transfer source model are displayed on the animation retargeting configuration interface. The animation transfer corrected model and the animation transfer source model may be referred to as a second animation transfer model pair. By using the animation transfer target model on which model correction processing is performed as an animation transfer corrected model, and displaying the animation transfer corrected model and the animation transfer source model on the animation retargeting configuration interface, an effect that the animation transfer corrected model and the animation transfer source model have the same spatial semantics information (for example, the animation transfer corrected model and the animation transfer source model have the same spatial semantics information “hands are put on the top of the head”, and in this case, the hands of the second object in the animation transfer source model are put on the top of the head, and the hands of the second object in the animation transfer corrected model are also put on the top of the head) may be presented more visually.

In the embodiments of this disclosure, the first local BV is constructed for the animation transfer source model and the second local BV is constructed for the animation transfer target model, so that the N first local object BVs associated with the first object and the M second local object BVs associated with the second object may be obtained. A spatial expression of the animation transfer source model may be formed by using the N first local object BVs, then spatial semantics detection may be performed on the N first local object BVs to obtain a spatial semantics detection result, and an effective interaction BV that satisfies the animation retargeting policy is sorted out from the N first local object BVs based on the spatial semantics detection result, thereby transferring spatial semantics information of the effective interaction BV to the second local object BV that satisfies the animation retargeting policy, to obtain a mapping BV. By directly transferring the spatial semantics information of the effective interaction BV, a transferred data volume is reduced, and retargeting efficiency can be improved to some extent. In addition, the spatial semantics information of the effective interaction BV is transferred to the second local object BV satisfying the animation retargeting policy, which means that in this embodiment of this disclosure, the spatial semantics information of the effective interaction BV in the mapping source model can be relatively precisely mapped to the corresponding second local object BV in the mapping target model, thereby improving the accuracy of spatial semantics transfer in the animation retargeting process. In this embodiment of this disclosure, model correction processing may be performed on the animation transfer target model including the mapping BV according to the model correction parameter determined according to the spatial semantics information, to obtain the animation transfer target model on which the model correction processing is performed. In this way, model correction processing may be automatically performed, so that spatial semantics information of the animation transfer target model on which the model correction processing is performed is kept consistent with that of the animation transfer source model without manual adjustment, thereby improving animation retargeting efficiency, effectively ensuring that spatial poses of the animation transfer target model on which the model correction is performed and the animation transfer source model are consistent, and also improving accuracy of spatial semantics transfer in the animation retargeting process and maintaining accuracy of spatial semantics transfer, to improve consistency between animation data presented by the animation transfer target model and that presented by the animation transfer source model. In addition, by using the animation transfer target model on which model correction processing is performed as an animation transfer corrected model, and displaying the animation transfer corrected model on the animation retargeting configuration interface, an effect of the animation transfer corrected model can be presented more visually.

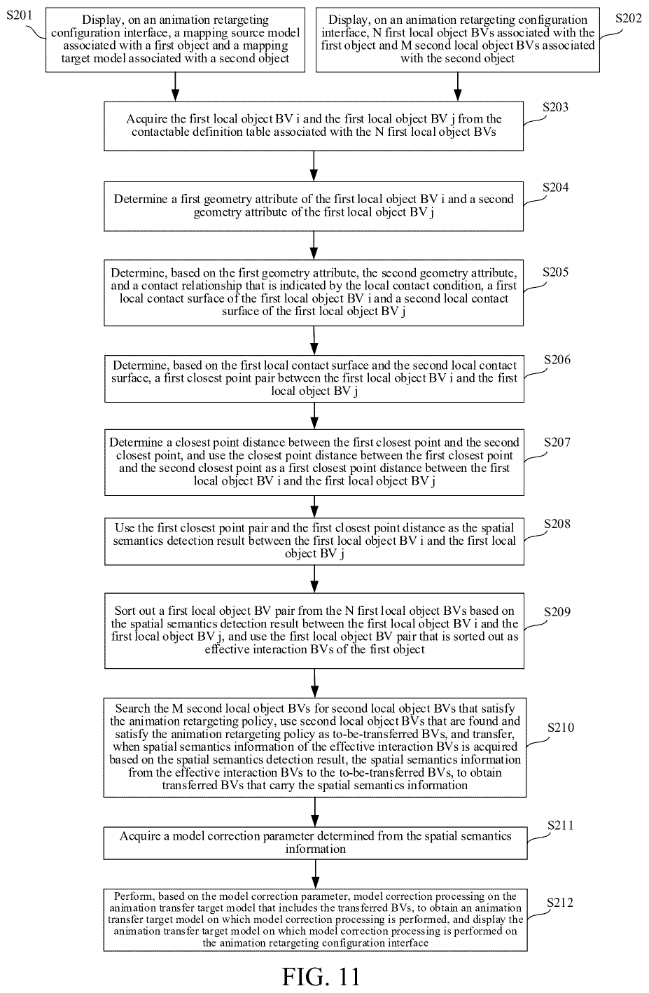

Refer to FIG. 11 below. FIG. 11 is a schematic flowchart of another animation retargeting method according to an embodiment of this disclosure. The animation retargeting method may be performed by a computer device, and the computer device may be the terminal device 101 or the server 102 in the foregoing animation retargeting system. For ease of understanding, an example in which the computer device is the terminal device 101 is used to describe the animation retargeting method provided in this embodiment of this disclosure. In the embodiments of this disclosure, the animation retargeting method may include at least the following operation S201 to operation S212:

Operation S201: Display, on an animation retargeting configuration interface, an animation transfer source model associated with a first object and an animation transfer target model associated with a second object.

Operation S202: Display, on an animation retargeting configuration interface, N first local object BVs associated with the first object and M second local object BVs associated with the second object, N and M being both positive integers; one first local object BV including one local object of the first object; and One second local object BV includes one local object of the second object. The N first local object BVs include a first local object BVᵢ and a first local object BV j; i is not equal to j, and i and j are both positive integers less than or equal to N.

For implementations of operation S201 and operation S202, refer to a specific implementation of operation S101, and details are not described herein again.

Operation S203: Acquire the first local object BVᵢ and the first local object BV j from the contactable definition table associated with the N first local object BVs.

The N first local object BVs include a first local object BVᵢ and a first local object BV j; i is not equal to j, and i and j are both positive integers less than or equal to N; the first local object BV i and the first local object BVⱼ are local object BVs that satisfy a local contact condition and that are in a contactable definition table; and the contactable definition table is configured for the animation transfer source model.

In this embodiment of this disclosure, alternatively, any two first local object BVs (for example, the first local object BVᵢ and the first local object BVⱼ) may be directly acquired from the N first local object BVs, and operation S204 is performed. In this embodiment of this disclosure, spatial semantics detection is mainly performed on the first local BVs that interact or may be in contact. Therefore, the acquiring the first local object BV i and the first local object BV j from the contactable definition table associated with the N first local object BVs can save a particular amount of calculation.

Operation S204: Determine a first geometry attribute of the first local object BV i and a second geometry attribute of the first local object BV j.

The first geometry attribute and the second geometry attribute may be the same attribute, or may be different attributes. The first geometry attribute may be a sphere attribute, a capsule attribute, a cube attribute, or the like. The second geometry attribute may be a sphere attribute, a capsule attribute, or a cube attribute.

Operation S205: Determine, based on the first geometry attribute, the second geometry attribute, and a contact relationship that is indicated by the local contact condition, a first local contact surface of the first local object BV i and a second local contact surface of the first local object BV j.

In some embodiments, operation S205 may include but is not limited to the following three cases:

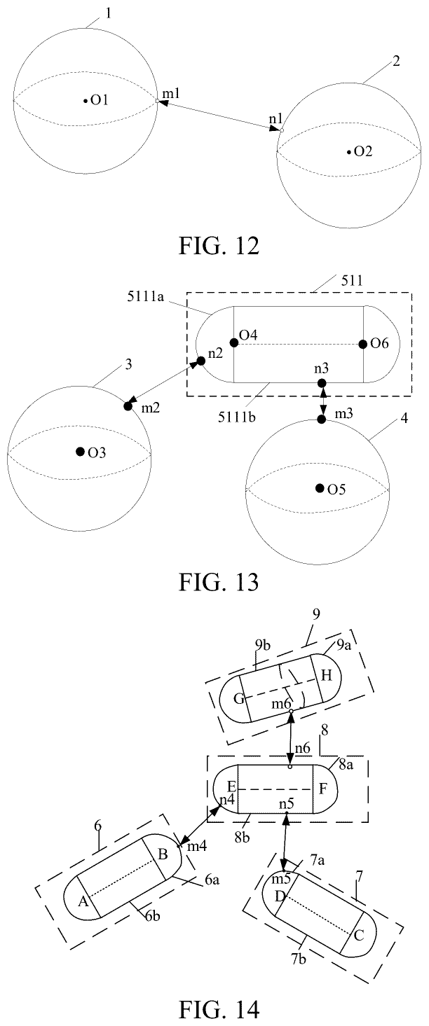

Case 1: The first geometry attribute is a sphere attribute, and the second geometry attribute is a sphere attribute. That is, the first local object BV i is a sphere, and the first local object BV j is a sphere. In this case, based on the first geometry attribute, the second geometry attribute, and the contact relationship that is indicated by the local contact condition, it may be determined that the first local contact surface of the first local object BVᵢ is a local sphere contact surface, and the second local contact surface of the first local object BV j is also a local sphere contact surface. As shown in FIG. 12, FIG. 12 is a schematic diagram of closest points between spheres according to an embodiment of this disclosure. The first local object BVᵢ is a sphere 1, and the first local object BV j is a sphere 2. In this case, based on the first geometry attribute, the second geometry attribute, and the contact relationship that is indicated by the local contact condition, it may be determined that the first local contact surface of the first local object BV i is a local sphere contact surface, and the second local contact surface of the first local object BV j is also a local sphere contact surface.

Case 2: The first geometry attribute is a sphere attribute, and the second geometry attribute is a capsule attribute. That is, the first local object BVᵢ is a sphere, the first local object BV j is a capsule, and the capsule includes a sphere and a cylinder.

It is assumed that the contact relationship indicated by the local contact condition is: The first local object BVᵢ is located on a side surface of a sphere included in the first local object BV j. As shown in FIG. 13, FIG. 13 is a schematic diagram of closest points between a sphere and a capsule according to an embodiment of this disclosure. A first local object BVᵢ is a sphere 3, a first local object BV j is a capsule 511, and the capsule 511 includes a sphere 5111a and a cylinder 5111b. The contact relationship indicated by the local contact condition includes that the sphere 3 is located on a side surface of the sphere 5111a included in the capsule 511. In this case, based on the first geometry attribute, the second geometry attribute, and the contact relationship that is indicated by the local contact condition, it may be determined that the first local contact surface of the first local object BVᵢ is a local sphere contact surface, and the second local contact surface of the first local object BV j is also a local sphere contact surface.

It is assumed that the contact relationship indicated by the local contact condition is: The first local object BV i is located on a side surface of a cylinder included in the first local object BV j. For example, in FIG. 13, if the contact relationship indicated by the local contact condition includes that the sphere 4 is located on a side surface of the cylinder 5111b included in the capsule 511, it may be determined that the first local contact surface of the first local object BV i is a local sphere contact surface, and the second local contact surface of the first local object BV j is a local cylinder contact surface.

Case 3: The first geometry attribute is a capsule attribute, and the second geometry attribute is a capsule attribute. That is, the first local object BVᵢ and the first local object BV j are capsules, and the capsule includes a sphere and a cylinder.

It is assumed that the contact relationship indicated by the local contact condition is: A cylinder center line segment of the first local object BVᵢ is not located on a side surface of a cylinder included in the first local object BV j and a cylinder center line segment of the first local object BV j is not located on a side surface of a cylinder included in the first local object BV i. For example, FIG. 14 is a schematic diagram of closest points between capsules. In FIG. 14, a first local object BV i is a capsule 6, and a first local object BV j is a capsule 8. In this case, the capsule 6 includes a sphere 6a and a cylinder 6b, and the capsule 8 includes a sphere 8a and a cylinder 8b. In this case, it may be seen that the contact relationship indicated by the local contact condition includes that the cylinder center line segment AB of the first local object BV i is not located on a side surface of the cylinder 8b included in the first local object BVⱼ. In this case, based on the first geometry attribute, the second geometry attribute, and the contact relationship that is indicated by the local contact condition, it may be determined that the first local contact surface of the first local object BV i is a local sphere contact surface, and the second local contact surface of the first local object BV j is also a local sphere contact surface.

It is assumed that the contact relationship indicated by the local contact condition is: A target endpoint of a cylinder center line segment of any local object BV (for example, the first local object BV i) of the first local object BVᵢ and the first local object BV j is located on a side surface of the cylinder of the other local object BV (for example, the first local object BV j). For example, in FIG. 14, a first local object BVᵢ is a capsule 7, and a first local object BV j is a capsule 8. In this case, the capsule 7 includes a sphere 7a and a cylinder 7b, and the capsule 8 includes a sphere 8a and a cylinder 8b. In this case, it may be seen that the contact relationship indicated by the local contact condition includes that an endpoint D of the cylinder center line segment CD of the first local object BV i is located on a side surface of the cylinder 8b included in the first local object BVⱼ. Then, it may be determined that the first local contact surface of the first local object BV i is a local sphere contact surface, and the second local contact surface of the first local object BV j is a local cylinder contact surface.

It is assumed that the contact relationship indicated by the local contact condition is: Closest points between the cylinder line segment of the first local object BV i and the cylinder line segment of the first local object BV j are projected on respective cylinder center line segments, and are located in the respective cylinder center line segments. For example, in FIG. 14, a first local object BVᵢ is a capsule 9, and a first local object BV j is a capsule 8. In this case, the capsule 9 includes a sphere 9a and a cylinder 9b, and the capsule 8 includes a sphere 8a and a cylinder 8b. In this case, closest points between the cylinder line segment of the first local object BV i and the cylinder line segment of the first local object BV j are respectively a point m6 and a point n6. In this case, the point m6 is projected on a cylinder center line segment GH and is located in the cylinder center line segment GH, and the point n6 is projected on a cylinder center line segment EF and is located in the cylinder center line segment EF. Then, it may be determined that the first local contact surface of the first local object BV i is a local cylinder contact surface, and the second local contact surface of the first local object BV j is a local cylinder contact surface.

Operation S206: Determine, based on the first local contact surface and the second local contact surface, a first closest point pair between the first local object BV i and the first local object BV j.

By connecting points on the first contact surface and the second contact surface, the first closest point pair between the first local contact surface and the second local contact surface may be determined. The first closest point pair between the first local object BV i and the first local object BV j includes: a first closest point of the first local object BV i (that is, a closest point on the first local BVᵢ) and a second closest point of the first local object BV j (that is, a closest point on the first local BVⱼ).

Operation S207: Determine a closest point distance between the first closest point and the second closest point, and use the closest point distance between the first closest point and the second closest point as a first closest point distance between the first local object BV i and the first local object BV j.

A closest point distance between the first closest point and the second closest point is a distance of the first closest point pair, that is, a distance between the first closest point and the second closest point. The closest point distance between the first closest point and the second closest point may be used as the first closest point distance between the first local object BV i and the first local object BV j. For the contact relationship indicated by the local contact condition, the first geometry attribute, and the second geometry attribute, it is determined that the closest point distance between the first closest point and the second closest point differs. Next, several manners of determining the closest point distance between the first closest point and the second closest point provided in this embodiment of this disclosure are described by using examples. How to determine the closest point distance between the first closest point and the second closest point is not limited in this embodiment of this disclosure.

Manner 1: The first geometry attribute and the second geometry attribute are both sphere attributes, that is, the first local object BV i and the first local object BV j are both spheres. In this case, the determining a closest point distance between the first closest point and the second closest point may include: determining a spherical center distance between a spherical center of the first local object BVᵢ and a spherical center of the first local object BV j; and determining the closest point distance between the first closest point and the second closest point according to the spherical center distance, a radius of the first local object BV i, and a radius of the first local object BV j.

A manner of determining the radius of the first local object BV i and the radius of the first local object BV j may be as follows: determining a spherical center of the first local object BV i, and determining the radius of the first local object BV i based on the spherical center of the first local object BV i and the first closest point; and then determining a spherical center of the first local object BV j, and determining the radius of the first local object BV j based on the spherical center of the first local object BVⱼ and the second closest point. For example, in FIG. 12, the first local object BV i is the sphere 1, and the first local object BV j is the sphere 2. In this case, the spherical center of the first local object BVᵢ is O1, the spherical center of the first local object BV j is O2, the first closest point is m1, and the second closest point is n1. The terminal device may calculate a distance between the first closest point and the spherical center O1 as the radius of the first local object BV i; and similarly may calculate a distance between the second closest point and the spherical center O2 as the radius of the first local object BV j. Then, a sum of the radius of the first local object BV i and the radius of the first local object BV j is subtracted from a spherical center distance between the spherical center O1 and the spherical center O2, to obtain a closest point distance between the first closest point and the second closest point. That is, the closest point distance is a distance between the first closest point m1 and the second closest point n1.

Manner 2: The first geometry attribute is a sphere attribute, and the second geometry attribute is a capsule attribute. That is, the first local object BVᵢ is a sphere, the first local object BV j is a capsule, and the first local object BV j includes a cylinder and a sphere.

In a case, the contact relationship indicated by the local contact condition is: The first local object BV i is located on a side surface of a sphere included in the first local object BV j. In this case, the determining a closest point distance between the first closest point and the second closest point may include: determining a spherical center distance between a spherical center of the first local object BVᵢ and a spherical center of the first local object BV j, and determining the closest point distance between the first closest point and the second closest point based on the spherical center distance between the spherical center of the first local object BV i and the spherical center of the first local object BV j, a radius of the first local object BV i, and a radius of the first local object BV j.

A manner of determining the radius of the first local object BV i and the radius of the first local object BV j may be: determining a radius of the first local object BV i based on the first closest point and the spherical center of the first local object BV i; and determining a radius of the first local object BV j based on the second closest point and the spherical center of the first local object BV j.

For example, in FIG. 13, the first local object BV i is the sphere 3, the spherical center of the first local object BVᵢ is O3, the first local object BV j is the capsule 511, and the spherical center of the first local object BV j is O4. The contact relationship indicated by the local contact condition includes that the first local object BV i is located on a side surface of the sphere 5111a included in the first local object BV j. The first closest point pair is a point m2 (that is, the first closest point) and a point n2 (that is, the second closest point). In this case, the terminal device may calculate a distance between the first closest point and the spherical center O3 of the first local object BV i as the radius of the first local object BV i, and then calculate a distance between the spherical center O4 of the first local object BV j and the second closest point as the radius of the first local object BV j; and then calculate a spherical center distance between the spherical center O3 and the spherical center O4, and determine the closest point distance between the first closest point and the second closest point according to the spherical center distance, and a radius sum of the radius of the first local object BV i and the radius of the first local object BV j. That is, the closest point distance is a closest point distance between the point m2 and the point n2.

In another case, the contact relationship indicated by the local contact condition is: The first local object BVᵢ is located on a side surface of a cylinder included in the first local object BV j. In this case, the determining a closest point distance between the first closest point and the second closest point may include: determining, based on a spherical center distance between a spherical center of the first local object BV i and a cylinder center line segment included in the first local object BV j, a radius of the first local object BV i, and a radius of the first local object BV j, the closest point distance between the first closest point and the second closest point.

A manner of determining the radius of the first local object BV i and the radius of the first local object BV j may be: determining a radius of the first local object BV i based on the first closest point and the spherical center of the first local object BV i; and determining a distance between the second closest point and the cylinder center line segment included in the first local object BV j as the radius of the first local object BV j.

For example, in FIG. 13, the first local object BV i is the sphere 4, and the first local object BV j is the capsule 511. In this case, the first closest point is m3, and the second closest point is n3. The terminal device may calculate a distance between the first closest point and the spherical center O5 of the first local object BV i as the radius of the first local object BV i, and use a distance between the second closest point n3 and the cylinder center line segment included in the first local object BV j as the radius of the first local object BV j; and then calculate a distance between the second closest point n3 and the cylinder center line segment O406 of the first local object BV j as the radius of the first local object BV j, then calculate a distance between the spherical center O5 of the first local object BV i and the cylinder center line segment O406 included in the first local object BV j, and subtract a radius sum of the radius of the first local object BVᵢ and the radius of the first local object BV j from the calculated distance, to obtain a closest point distance between the first closest point and the second closest point. That is, the closest point distance is a distance between m3 and n3.

Manner 3: The first geometry attribute is a capsule attribute, and the second geometry attribute is a capsule attribute. That is, the first local object BVᵢ is a capsule, and the first local object BV j is a capsule. The first local object BV j includes a cylinder and a sphere; the first local object BV j includes a cylinder and a sphere; and the first closest point pair includes a first closest point on the first local object BVᵢ and a second closest point on the first local object BV j.

In a case, the contact relationship indicated by the local contact condition indicates: A cylinder center line segment of the first local object BV i is not located on a side surface of a cylinder included in the first local object BV j and a cylinder center line segment of the first local object BV j is not located on a side surface of a cylinder included in the first local object BV i. In this case, the determining a closest point distance between the first closest point and the second closest point may include: determining, if the contact relationship indicated by the local contact condition includes that a cylinder center line segment of the first local object BVᵢ is not located on a side surface of a cylinder included in the first local object BV j and a cylinder center line segment of the first local object BV j is not located on a side surface of a cylinder included in the first local object BV i, a closest endpoint distance between the cylinder center line segment of the first local object BV i and the cylinder center line segment of the first local object BV j; and determining, based on the closest endpoint distance, a radius of the first local object BV i, and a radius of the first local object BV j, the closest point distance between the first closest point and the second closest point.

A manner of determining the radius of the first local object BV i and the radius of the first local object BV j may be: using a distance between the first closest point and the spherical center of the first local object BVᵢ as the radius of the first local object BV i, and determining a distance between the second closest point and the spherical center of the first local object BV j as the radius of the first local object BV j. For example, in FIG. 14, a first local object BV i is a capsule 6, and a first local object BV j is a capsule 8. In this case, the capsule 6 includes a sphere 6a and a cylinder 6b, and the capsule 8 includes a sphere 8a and a cylinder 8b. In this case, it may be seen that the contact relationship indicated by the local contact condition includes that the cylinder center line segment AB of the first local object BV i is not located on a side surface of the cylinder 8b included in the first local object BV j. The first closest point on the first local object BV i is m4 and the second closest point on the first local object BV j is n4. The terminal device may use a distance between the first closest point m4 and the spherical center B of the first local object BV i as the radius of the first local object BV i, use a distance between the second closest point n4 and the spherical center E of the first local object BV j as the radius of the first local object BV j, then determine a closest endpoint distance between a cylinder center line segment of the first local object BV i and a cylinder center line segment of the first local object BV j (that is, a distance between the closest endpoint B and the closest endpoint E), and determine a closest point distance between the first closest point m4 and the second closest point n4 based on the closest endpoint distance BE, the radius of the first local object BV i, and the radius of the first local object BV j.

In another case, the contact relationship indicated by the local contact condition is: A target endpoint of a cylinder center line segment of any local object BV of the first local object BV i and the first local object BV j is located on a side surface of a cylinder of the other local object BV. The target endpoint is an endpoint on a cylinder center line segment of any local object BV that is closest to a side surface of a cylinder of the other local object BV. In this embodiment of this disclosure, the contact relationship indicated by the local contact condition includes that a target endpoint of a cylinder center line segment of the first local object BV i is located on a side surface of a cylinder of the first local object BV j, or the contact relationship indicated by the local contact condition includes that a target endpoint of a cylinder center line segment of the first local object BV j is located on a side surface of a cylinder of the first local object BV i. For example, in FIG. 14, a first local object BV i is a capsule 7, and a first local object BV j is a capsule 8. In this case, the capsule 7 includes a sphere 7a and a cylinder 7b, and the capsule 8 includes a sphere 8a and a cylinder 8b. In this case, the target endpoint is the endpoint D of the cylinder center line segment CD of the first local object BV i. In this case, the contact relationship indicated by the local contact condition includes that an endpoint D of the cylinder center line segment CD of the first local object BVᵢ is located on a side surface of the cylinder 8b included in the first local object BV j. The determining, by the terminal device, a closest point distance between the first closest point and the second closest point may include: determining, if the contact relationship indicated by the local contact condition includes that in the first local object BV i and the first local object BV j, a target endpoint of a cylinder center line segment of any local object BV is located on a side surface of a cylinder of the other local object BV, a target distance between the target endpoint of the cylinder center line segment of the any local object BV and a cylinder center line segment of the other local object BV; and determining, based on the target distance, a radius of the first local object BV i, and a radius of the first local object BV j, the closest point distance between the first closest point and the second closest point.

A manner of determining the radius of the first local object BV i and the radius of the first local object BV j is: determining a distance between the first closest point and the spherical center of the first local object BVᵢ as the radius of the first local object BV i, and determining a distance between the second closest point and the cylinder center line segment of the first local object BV j as the radius of the first local object BV j. For example, in FIG. 14, the first closest point is m5, and the second closest point is n5. In this case, a distance between the first closest point m5 and the spherical center D may be determined as the radius of the first local object BV i, a distance between the second closest point n5 and the cylinder center line segment EF of the first local object BV j is determined as the radius of the first local object BV j, and then a target distance between the target endpoint D of the cylinder center line segment of the first local object BV i and the cylinder center line segment EF of the first local object BV j is determined; and the closest point distance between the first closest point m5 and the second closest point n5 is determined based on the target distance, a radius of the first local object BV i, and a radius of the first local object BV j.

In still another case, the contact relationship indicated by the local contact condition is: The first closest point of the cylinder line segment of the first local object BVᵢ and the second closest point of the cylinder line segment of the first local object BV j are projected on respective cylinder center line segments, and are located in the respective cylinder center line segments. In this case, the determining a closest point distance between the first closest point and the second closest point includes: determining, if the contact relationship indicated by the local contact condition indicates that the first closest point and the second closest point are respectively projected on respective cylinder center line segments and are located in the respective cylinder center line segments, a second closest point distance between a spatial straight line corresponding to the cylinder center line segment of the first local object BV i and a spatial straight line corresponding to the cylinder center line segment of the first local object BV j; and determining, based on the second closest point distance, the radius of the first local object BV i, and the radius of the first local object BV j, the closest point distance between the first closest point and the second closest point.

A manner of determining the radius of the first local object BV i and the radius of the first local object BV j may be: determining a distance from the first closest point to the first local object BV i as the radius of the first local object BV i; and determining a distance from the second closest point to the first local object BVⱼ as the radius of the first local object BV j. For example, in FIG. 14, the first closest point is m6, and the second closest point is n6. In this case, a distance between the first closest point m6 and the cylinder center line segment GH of the first local object BV i may be determined as the radius of the first local object BV i, a distance between the second closest point n6 and the cylinder center line segment EF of the first local object BVᵢ is determined as the radius of the first local object BV j, then a second closest point distance between a spatial straight line corresponding to the cylinder central line segment GH and a spatial straight line corresponding to the cylinder central line segment EF is determined, and the closest point distance between the first closest point m6 and the second closest point n6 is determined based on the second closest point distance, the radius of the first local object BV i, and the radius of the first local object BV j.

In this embodiment of this disclosure, the distance obtained based on the second closest point distance, the radius of the first local object BV i, and the radius of the first local object BV j may be used as the closest point distance between the first closest point m6 and the second closest point n6.

A sequence of operation S206 and operation S207 is not limited, and operation S206 and operation S207 may alternatively be performed simultaneously. That is, the first closest point pair and the closest point distance may be actually determined together. For example, when the closest point distance is determined, the closest point distance is actually a connection line between closest points on the first local BV i and the first local object BV j. The first closest point and the second closest point may be found according to the closest point distance.

Operation S208: Determine the first closest point pair and the first closest point distance as the spatial semantics detection result between the first local object BV i and the first local object BV j.

Operation S209: Sort out, based on the spatial semantics detection result between the first local object BV i and the first local object BV j, a first local object BV pair satisfying an animation retargeting policy from the N first local object BVs, and determine the first local object BV pair that is sorted out and satisfies the animation retargeting policy as effective interaction BVs of the first object.

In an embodiment, if the first closest point distance between the first local object BV i and the first local object BV j is less than the interaction distance threshold, the first local object BV i and the first local object BVⱼ are used as the first local object BV pair that is sorted out from the N first local object BVs and satisfies the animation retargeting policy. The effective interaction BVs may include the first local object BV pair. The first local object BV pair may include the first local object BV i and the first local object BV j.

Operation S210: Search the M second local object BVs for second local object BVs that satisfy the animation retargeting policy, use second local object BVs that are found and satisfy the animation retargeting policy as to-be-transferred BVs, and transfer, when spatial semantics information of the effective interaction BVs is acquired based on the spatial semantics detection result, the spatial semantics information from the effective interaction BVs to the to-be-transferred BVs, to obtain transferred BVs that carry the spatial semantics information.

A geometry attribute of the first to-be-transferred BV is the same as a geometry attribute of the first effective interaction BV. A geometry attribute of the second to-be-transferred BV is the same as a geometry attribute of the second effective interaction BV. For example, if the first effective interaction BV is a sphere, the first to-be-transferred BV is also a sphere. The spatial semantics information of the effective interaction BV is configured for constraining a spatial relationship between corresponding second local object BVs of the animation transfer target model. Therefore, it is required that during transfer, a shape-invariant and an orientation-invariant need to be ensured. Therefore, a spatial semantics transfer descriptor is introduced in this embodiment of this disclosure, and the spatial semantics transfer descriptor is configured for describing spatial semantics information between the first effective interaction BV and the second effective interaction BV of the effective interaction BVs. That is, the spatial semantics transfer descriptor may include at least one of a proportion coefficient (that is, an scp ratio) and a local vector. The proportion coefficient is configured for describing a proportion of the closest point to an axial vector of the effective interaction BV, and the local vector is configured for describing local coordinates on a coordinate system using the effective interaction BV as a center. The spatial semantics information may include a closest point pair between the first effective interaction BV (for example, the first local object BVᵢ) and the second effective interaction BV (for example, the first local object BV j). The spatial semantics information further includes first effective spatial semantics information of the first effective interaction BV and second effective spatial semantics information of the second effective interaction BV. The closest point pair between the first effective interaction BV and the second effective interaction BV includes a closest point of the first effective interaction BV and a closest point of the second effective interaction BV. A manner of acquiring the spatial semantics information of the effective interaction BV may be: constructing a first coordinate system based on the first effective interaction BV, and determining a vector pointing from an origin of the first coordinate system to the closest point of the first effective interaction BV as a local vector of the closest point of the first effective interaction BV; and then generating, based on the local vector of the closest point of the first effective interaction BV, the first spatial semantics information of the first effective interaction BV. Similarly, a second coordinate system is constructed based on the second effective interaction BV, and a vector pointing from an origin of the second coordinate system to the closest point of the second effective interaction BV is determined as a local vector of the closest point of the second effective interaction BV; and then the second spatial semantics information of the second effective interaction BV is generated based on the local vector of the closest point of the second effective interaction BV, and finally, spatial semantics information of the effective interaction BV is generated based on the first spatial semantics information of the first effective interaction BV and the second spatial semantics information of the second effective interaction BV.

When the first effective interaction BV is a sphere, the origin of the constructed first coordinate system may be a spherical center. When the first effective interaction BV is a capsule, the origin of the constructed first coordinate system may be a midpoint on a cylinder center line segment of the capsule. The second effective interaction BV is similar to the first effective interaction BV, and details are not described herein again.

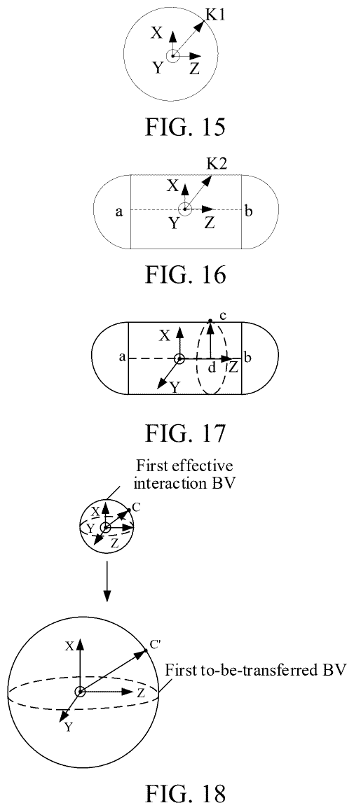

For ease of understanding, refer to FIG. 15. FIG. 15 is a schematic diagram of a local vector of a closest point of a first effective interaction BV according to an embodiment of this disclosure. In FIG. 15, the closest point of the first effective interaction BV is a point K1, the first effective interaction BV is a sphere, and a first coordinate system XYZ is constructed by using a spherical center of the first effective interaction BV as an origin. In this case, a vector pointing from the origin of the first coordinate system to the closest point K1 of the first effective interaction BV is used as a local vector of the closest point K1 of the first effective interaction BV. For another example, as shown in FIG. 16, FIG. 16 is another schematic diagram of a local vector of a closest point of a first effective interaction BV according to an embodiment of this disclosure. In FIG. 16, the closest point of the first effective interaction BV is a point K2, the first effective interaction BV is a capsule, and a first coordinate system XYZ is constructed by using a center of a cylinder center line segment ab of the first effective interaction BV as an origin. In this case, a vector pointing from the origin of the first coordinate system to the closest point K2 of the second effective interaction BV is used as a local vector of the closest point K2 of the first effective interaction BV. A vector pointing from the origin of the first coordinate system to the closest point of the first effective interaction BV is local coordinates of the first effective interaction BV in the first coordinate system.

When the first effective interaction BV or the second effective interaction BV is a capsule, because the first spatial semantics information of the first effective interaction BV and the second spatial semantics information of the second effective interaction BV are generated in similar manners. Therefore, the first effective interaction BV is used as an example, and the generating, based on the local vector of the closest point of the first effective interaction BV, the first spatial semantics information of the first effective interaction BV includes: determining a proportion coefficient corresponding to the closest point of the first effective interaction BV on an axial vector of the first local object BV i; then projecting the local vector of the first effective interaction BV, to obtain a projection vector of the closest point of the first effective interaction BV; and finally, generating first spatial semantics information of the first effective interaction BV based on the proportion coefficient and the projection vector that correspond to the closest point of the first effective interaction BV. The axial vector of the first local object BV i is the cylinder center line segment of the first local object BV.

For ease of understanding, refer to FIG. 17. FIG. 17 shows a process of determining a proportion coefficient corresponding to a closest point of a first effective interaction BV according to an embodiment of this disclosure. The closest point of the first effective interaction BV is c, a projection point of the closest point c on an axial vector is d, an axial vector of the first effective interaction BV is ab, and a proportion coefficient α corresponding to the closest point c on the axial vector ab of the first local object BVᵢ is expressed as the following formula (1):

$$α = ad / ab \qquad ( 1 )$$

where α∈(0˜1), ad is a vector from a point a to the projection point d, and ab is the axial vector of the first effective interaction BV.

In this embodiment of this disclosure, the projecting the local vector of the first effective interaction BV, to obtain a projection vector of the closest point of the first effective interaction BV is: projecting the local vector of the first effective interaction BV along target axes, to obtain a projection vector of the closest point of the first effective interaction BV. For example, the first coordinate system includes an X axis, a Y axis, and a Z axis, and then the target axes are the X axis and the Y axis, that is, the local vector of the first effective interaction BV is projected onto an X-Y surface, to obtain the projection vector. When the first effective interaction BV or the second effective interaction BV is a sphere, there is no need to determine the proportion coefficient corresponding to the corresponding closest point and there is no need to project the local vector.

In some embodiments, the transferring the spatial semantics information from the effective interaction BVs to the to-be-transferred BVs, to obtain transferred BVs that carry the spatial semantics information may include: determining a first position point on the first to-be-transferred BV that has the same first spatial semantics information as that of the closest point of the first effective interaction BV, and determining a second position point on the second to-be-transferred BV that has the same second spatial semantics information as that of the closest point of the second effective interaction BV; transferring the first spatial semantics information of the closest point of the first effective interaction BV to the first position point, to obtain the first transferred BV carrying the first spatial semantics information; transferring the second spatial semantics information of the closest point of the second effective interaction BV to the second position point, to obtain the second transferred BV carrying the second spatial semantics information; and determining, based on the first transferred BV carrying the first spatial semantics information and the second transferred BV carrying the second spatial semantics information, the transferred BVs carrying the spatial semantics information.

The first position point on the first to-be-transferred BV that has the same first spatial semantics information as that of the closest point of the first effective interaction BV may be determined in the following manner: establishing a third coordinate system by using the first to-be-transferred BV, and determining, in the third coordinate system according to the local vector included in the first spatial semantics information, a first position point having first spatial semantics information the same as that of a closest point of a first effective interaction BV. For ease of understanding, refer to FIG. 18. FIG. 18 is a schematic diagram of determining a first position point having first spatial semantics information the same as that of a closest point of a first effective interaction BV according to an embodiment of this disclosure. The first effective interaction BV is a sphere, and the first to-be-transferred BV is also a sphere. In this case, a third coordinate system is established by using the spherical center of the first to-be-transferred BV, and a point C′ may be found from the first to-be-transferred BV according to the local vector included in the first spatial semantics information and in a direction indicated by the local vector and starting from the origin of the third coordinate system. In this case, the point C′ on the first to-be-transferred BV and a point C on the first effective interaction BV have the same first spatial semantics information.

When the first to-be-transferred BV is a sphere, the origin of the constructed first coordinate system may be a spherical center. When the first to-be-transferred BV is a capsule, the origin of the constructed first coordinate system may be a midpoint on a cylinder center line segment of the capsule. The second to-be-transferred BV is similar to the first to-be-transferred BV, and details are not described herein again.

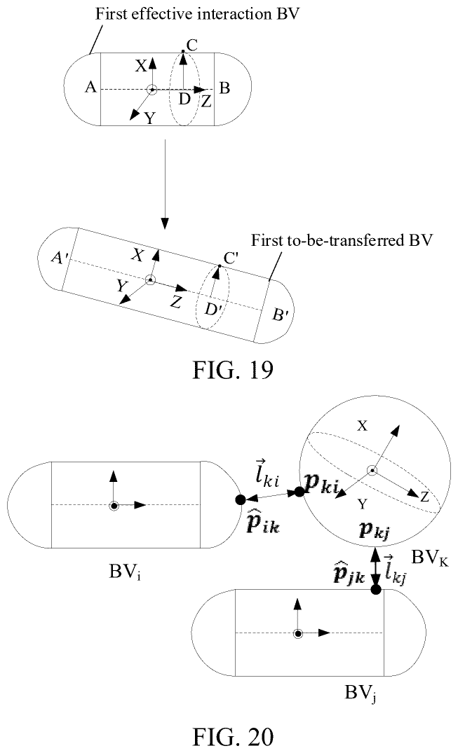

When the first spatial semantics information includes a proportion coefficient and a projection vector that correspond to the closest point of the first effective interaction BV, the first position point on the first to-be-transferred BV that has the same first spatial semantics information as that of the closest point of the first effective interaction BV may be determined in the following manner: establishing a fourth coordinate system by using the first to-be-transferred BV, determining, according to a proportion coefficient included in the first spatial semantics information, candidate position points satisfying the proportion coefficient on an axial vector of the first to-be-transferred BV, and then determining, according to the projection vector included in the first spatial semantics information and the candidate position points satisfying the proportion coefficient, the first position point having first spatial semantics information the same as that of the closest point of the first effective interaction BV. For example, FIG. 19 is another schematic diagram of determining a first position point having first spatial semantics information the same as that of a closest point of a first effective interaction BV according to an embodiment of this disclosure. The first effective interaction BV is a capsule, a coordinate system is established by using a midpoint of an axial vector AB of the first effective interaction BV, a closest point of the first effective interaction BV is a point C, and the first to-be-transferred BV is also a capsule. In this case, a fourth coordinate system is also established by using a midpoint of the axial vector A′B′ of the first to-be-transferred BV. First, a position point D′ satisfying a proportion coefficient is determined on the axial vector A′B′ of the first to-be-transferred BV. Then, on the fourth coordinate system established by using the first to-be-transferred BV, a point C′ is found according to a direction indicated by a projection vector included in the first spatial semantics information and the position point satisfying the proportion coefficient. That is, the point C′ is a first position that is on the to-be-transferred BV and that has first spatial semantics information the same as that of a point C on the first effective interaction BV.

An implementation of determining the second position point on the second to-be-transferred BV that has the same second spatial semantics information as that of the closest point of the second effective interaction BV is similar to the implementation of determining the first position point on the first to-be-transferred BV that has the same first spatial semantics information as that of the closest point of the first effective interaction BV. Details are not described herein again.

Operation S211: Acquire a model correction parameter determined from the spatial semantics information.

After operation S210 of transferring the spatial semantics information from the effective interaction BV to the to-be-transferred BV is performed, invariant semantics point transfer is completed. That is, spatial semantics of the closest point of the first effective interaction BV is the same as that of the first position point on the first transferred BV, and spatial semantics of the closest point of the second effective interaction BV is the same as that of the first position point on the second transferred BV. Therefore, effective interaction also exists between the first transferred BV and the second transferred BV. The first position point and the second position point are the second closest point pair between the first transferred BV and the second transferred BV. That is, the first position point is the closest point on the first transferred BV, and the second position point is the closest point on the second transferred BV.

To keep a spatial relationship of the animation transfer target model including the transferred BV consistent with a spatial relationship of the animation transfer source model, in this embodiment of this disclosure, the animation transfer target model including the transferred BV may be corrected through IK adjustment, that is, an EEF in the animation transfer target model including the transferred BV is determined, and an interaction transferred BV having effective interaction with the EEF is determined in the animation transfer target model including the transferred BV; and then a target position of the EEF may be calculated according to the interaction transferred BV having effective interaction with the EEF, and the EEF. Therefore, a model correction parameter corresponding to the target position to which adjustment is required is determined, and the EEF may be adjusted from a current position to the target position based on the model correction parameter, to complete correction of the animation transfer target model including the transferred BV. In this case, the model correction parameter determined according to the spatial semantics information may be acquired in the following manner: First, the first transferred BV used as an EEF is determined in the animation transfer target model including the transferred BV, the second transferred BV (that is, an interaction transferred BV) having effective interaction with the first transferred BV is determined, and the first position point and the second position point are used as a second closest point pair between the first transferred BV and the second transferred BV; then, a closest point distance between the first effective interaction BV and the second effective interaction BV is superposed for a second position point in the second closest point pair along a direction perpendicular to a surface of the first transferred BV (the closest point distance between the first effective interaction BV and the second effective interaction BV is determined by the foregoing spatial semantics detection, and the closest point distance between the first effective interaction BV and the second effective interaction BV is a closest point distance between a closest point of the first effective interaction BV and a closest point of the second effective interaction BV), to obtain an interaction estimation point corresponding to the second position point; then an adjustment vector of the first transferred BV is determined based on the interaction estimation point corresponding to the first transferred BV, the first position point in the second closest point pair, and an adjustment weight; and finally, the model correction parameter is generated based on the adjustment vector of the first transferred BV.

In the embodiments of this disclosure, a quantity of second transferred BVs having effective interaction with the first transferred BV may be R. In this case, the acquiring a model correction parameter determined from the spatial semantics information may include: determining the first transferred BV as an EEF in the animation transfer target model including the transferred BVs, and determining the R second transferred BVs having effective interaction with the first transferred BV. In this case, there are R first position points in the first transferred BV, and each first position point of the first transferred BV and a second position point on a corresponding second transferred BV constitute a second closest point pair between the second transferred BV and the first transferred BV. That is, when a quantity of second transferred BVs having effective interaction with the first transferred BV may be R, there are R second closest point pairs. That is, a closest point pair exists between each second transferred BV of the R second transferred BVs and the first transferred BV. After operation S210, the terminal device may acquire a second closest point pair between the first transferred BV and a second transferred BV t, where the second closest point pair between the first transferred BV and the second transferred BV t includes a closest point t (that is, a first position point) on the first transferred BV and a closest point on the second transferred BV t (that is, a second position point on the second transferred BV t), where t is a positive integer less than or equal to R; then superpose, for a closest point of the second transferred BV t, a closest point distance between the first effective interaction BV and the second effective interaction BV corresponding to the second transferred BV t along a direction perpendicular to a surface of the first transferred BV, to obtain an interaction estimation point corresponding to the second position point of the second transferred BV t; determine an adjustment vector of the first transferred BV based on the interaction estimation point corresponding to the second position point of the second transferred BV t, the first position point in the second closest point pair, and an adjustment weight associated with the interaction estimation point corresponding to the second position point of the second transferred BV t; and generate the model correction parameter based on the adjustment vector of the first transferred BV.

For ease of understanding, refer to FIG. 20. FIG. 20 is a schematic diagram of calculation of an interaction estimation point corresponding to a first transferred BV according to an embodiment of this disclosure. An example in which a quantity of second transferred BVs having effective interaction with a first transferred BV is 2 is used. The terminal device may determine, in the animation transfer target model including the transferred BV, that the first transferred BV used as the EEF is BVₖ, and a target position of the first transferred BV BVₖ is determined by two second transferred BVs (that is, BVᵢ and BVⱼ) having effective interaction with the first transferred BV, that is, the second transferred BVs having effective interaction with the first transferred BV BVₖ are BVᵢ and BVⱼ. In the animation transfer source model, the first transferred BV corresponds to the first effective interaction BV, and the second transferred BV BVᵢ corresponds to the second effective interaction BV 1; the second transferred BV BVⱼ corresponds to the second effective interaction BV 2; a closest point distance between the first effective interaction BV and the second effective interaction BV 1 is \vec{l}ₖᵢ; a closest point distance between the first effective interaction BV and the second effective interaction BV 2 is \vec{l}ₖⱼ; after the spatial semantics transfer is performed in operation S210, a second closest point pair between the first transferred BV BVₖ and the second transferred BV BVᵢ (that is, the second closest point pair between the first transferred BV BVₖ and the second transferred BV BVᵢ includes a closest point pₖᵢ on the first transferred BV BVₖ and a closest point pix on the second transferred BV BVᵢ) may be determined; similarly, a second closest point pair between the first transferred BV BVₖ and the second transferred BV BVⱼ (that is, the second closest point pair between the first transferred BV BVₖ and the second transferred BV BVⱼ includes a closest point pₖⱼ on the first transferred BV BVₖ and a closest point \hat{P}ⱼₖ on the second transferred BV BVⱼ) is determined; then, a closest point distance \vec{l}ₖᵢ between the first effective interaction BV and the second effective interaction BV 1 is superposed for \hat{p}ᵢₖ on the second transferred BV BVᵢ along a direction perpendicular to a surface of the first transferred BV BVₖ, to obtain an interaction estimation point \hat{p}ₖᵢ corresponding to \hat{p}ᵢₖ; and then, a closest point distance \vec{l}ₖⱼ between the first effective interaction BV and the second effective interaction BV 2 is superposed for \hat{p}ⱼₖ on the second transferred BV BVⱼ along the direction perpendicular to the surface of the first transferred BV BVₖ, to obtain an interaction estimation point \hat{p}ₖⱼ corresponding to \hat{p}ⱼₖ. Then, an adjustment weight associated with the interaction estimation point \hat{p}ₖⱼ and an adjustment weight associated with the interaction estimation point \hat{p}ₖᵢ are determined, and then, an adjustment vector of the first transferred BV BVₖ is determined according to the interaction estimation point \hat{p}ₖᵢ, the closest pointpₖᵢ, the adjustment weight associated with the interaction estimation point \hat{p}ₖᵢ, the interaction estimation point \hat{p}ₖⱼ, the closest point pₖⱼ, and the adjustment weight associated with the interaction estimation point \hat{p}ₖⱼ.

In this embodiment of this disclosure, a manner of calculating the adjustment vector of the first transferred BV is shown by the following formula (2) and formula (3):

$${\vec{P}}_{adjust} = {\sum }_{t = i , j} {w}_{kt} \times ( {\hat{p}}_{kt} - {P}_{kt} ) \qquad ( 2 )$$

$${\hat{P}}_{kt} = {\hat{P}}_{tk} + {\vec{l}}_{kt} \qquad ( 3 )$$

where \vec{P}_{adjust} represents the adjustment vector of the first transferred BV. wₖₜ represents the adjustment weight associated with the interaction estimation point corresponding to the second position point of the second transferred BV t. \hat{p}ₖₜ represents the interaction estimation point corresponding to the second position point of the second transferred BV t; and \vec{l}ₖᵢ represents a closest point distance between the first effective interaction BV corresponding to the first transferred BV and the second effective interaction BV corresponding to the second transferred BV t in the animation transfer source model. \hat{P}ₜₖ represents the second position point (that is, the closest point) on the second transferred BV t.

A manner of determining the adjustment weight associated with the interaction estimation point corresponding to the second position point of the second transferred BV tis: calculating a sum of closest point distances between the first effective interaction BV and the second effective interaction BVs corresponding to the second transferred BVs, to obtain a total distance sum, and determining the adjustment weight associated with the interaction estimation point corresponding to the second position point of the second transferred BV t according to the closest point distance between the first effective interaction BV and the second effective interaction BV corresponding to the second transferred BV t.

The weight wₖₜ may be calculated by using the following formula (4):

$${w}_{kt} = \frac{1 / ( m ‖ {\vec{l}}_{kt} ‖ )}{{\sum }_{t = i , j} 1 / ( m ‖ {\vec{l}}_{kt} ‖ )} \qquad ( 4 )$$

where ∥lₖₜ∥ is an absolute value of the closest point distance between the first effective interaction BV corresponding to the first transferred BV and the second effective interaction BV corresponding to the second transferred BV t in the animation transfer source model, where m is a constant.

The foregoing merely provides an exemplary process of determining the model correction parameter when the first transferred BV is used as an EEF. When the EEF is another BV in the animation transfer target model including the transferred BV, refer to a specific implementation of determining the model correction parameter by using the first transferred BV. Details are not described herein again.

The second local object BV used as an EEF may be set in the animation retargeting configuration interface by using an EEF setting option. In addition, as can be learned from the foregoing description, the transferred BV is the second local object BV to which the spatial semantics information is transferred. The terminal device may acquire an EEF configuration file associated with the animation transfer target model, and determine the first transferred BV used as the EEF from the transferred BV based on the EEF configuration file.

The performing, based on the model correction parameter, model correction processing on the animation transfer target model that includes the transferred BVs may include: first performing, based on the adjustment vector of the first transferred BV, translation adjustment on the first transferred BV in the animation transfer target model, to obtain a first transferred BV on which translation adjustment is performed; and then performing, based on the first transferred BV on which translation adjustment is performed, model correction processing on the animation transfer target model, to obtain an animation transfer target model on which model correction processing is performed. Therefore, the local object included in the first transferred BV reaches a target position, and model correction processing on the animation transfer target model is completed. The target position herein is an actual position of the first transferred BV.

Operation S212: Perform, based on the model correction parameter, model correction processing on the animation transfer target model that includes the transferred BVs, to obtain an animation transfer target model on which model correction processing is performed, and display the animation transfer target model on which model correction processing is performed on the animation retargeting configuration interface. The animation transfer target model on which model correction processing is performed and the animation transfer target model on which model correction processing is performed have the same spatial semantics information. That is, the animation transfer corrected model and the animation transfer source model have the same spatial semantics information.

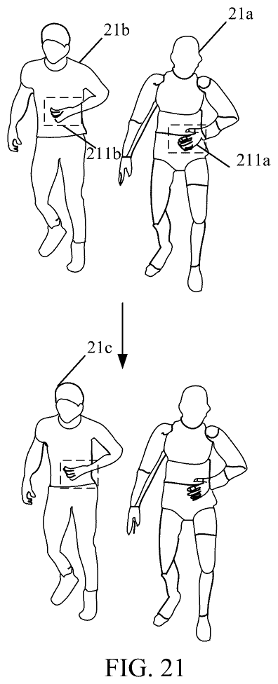

The performing, based on the model correction parameter, model correction processing on the animation transfer target model that includes the transferred BVs, to obtain an animation transfer target model on which model correction processing is performed may include: first performing translation adjustment on the first transferred BV along the adjustment vector, to obtain a first transferred BV on which translation adjustment is performed; and then performing, based on the first transferred BV on which translation adjustment is performed, model correction processing on the animation transfer target model, to obtain a final animation transfer target model on which model correction processing is performed. For example, as shown in FIG. 21, FIG. 21 is a schematic diagram of comparison between an animation transfer target model including a transferred BV and an animation transfer target model on which model correction processing is performed according to an embodiment of this disclosure. In FIG. 21, a spatial semantics relationship between a hand and a thorax included in an animation transfer source model 21a is shown by 211a in FIG. 21. An animation transfer target model 21b including a transferred BV and on which transfer is performed is inconsistent with the animation transfer source model in a spatial semantics relationship between a hand and a thorax due to an excessively high position of contact between a hand and a thorax in a body proportion (as shown by 211b in FIG. 21). In this case, model correction processing is performed, based on the model correction parameter, on the animation transfer target model that includes the transferred BV, to obtain an animation transfer target model on which model correction processing is performed, and the spatial semantics relationship between the hand and the thorax of the animation transfer target model 21c on which model correction processing is performed is kept consistent with the spatial semantics relationship between the hand and the thorax of the animation transfer source model 21a.

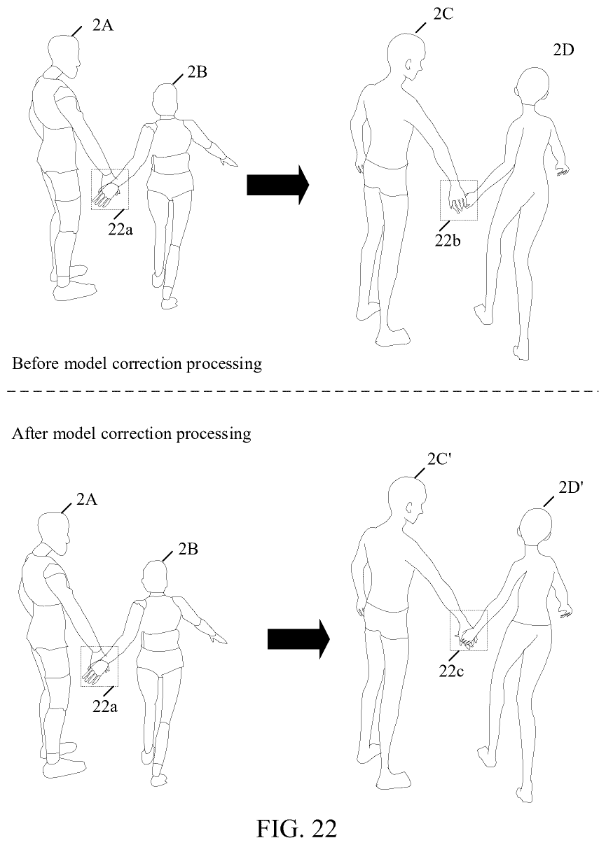

The second object includes L second sub-objects. When the first transferred BV is a transferred BV associated with a target second sub-object, it means that there is interaction between different second sub-objects. In this case, the model correction parameter may include an end adjustment weight and a root adjustment weight. In this case, an end adjustment weight and a root adjustment weight that correspond to a case that the first transferred BV is adjusted may be determined based on the adjustment vector; the first transferred BV is adjusted based on the end adjustment weight and the animation transfer target sub-model in which the first transferred BV is located is adjusted based on the root adjustment weight, to obtain the animation transfer target sub-model on which model correction processing is performed; and the animation transfer target model on which model correction processing is performed is obtained based on the animation transfer target sub-model on which model correction processing is performed. The target second sub-object is any one of the L second sub-objects. Spatial semantics of the animation transfer target model on which model correction processing is performed and spatial semantics of the animation transfer source model are better retained. For example, FIG. 22 is a schematic diagram of comparison between an animation transfer target model including a transferred BV and an animation transfer target model on which model correction processing is performed. In FIG. 22, an animation transfer source model includes an animation transfer source sub-model 2A associated with a first sub-object 1 and an animation transfer source sub-model 2B associated with a second sub-object 2, and an animation transfer target model including a transferred BV includes an animation transfer target model 2C associated with a second sub-object 3 and an animation transfer target model 2D associated with a second sub-object 4. In FIG. 22, a hand holding effect (that is, spatial semantics information of hand holding) between the animation transfer source sub-model 2A and the animation transfer source sub-model 2B can be seen. As shown by 22a in FIG. 22, a hand holding effect (that is, shown by 22b in FIG. 22) between the animation transfer target sub-model 2C and the animation transfer target sub-model 2D is not preserved in spatial semantics. Model correction processing is performed on the animation transfer target sub-model 2C and the animation transfer target sub-model 2D, and an achieved hand holding effect (that is, shown by 22c in FIG. 22) between an animation transfer target sub-model 2C′ and an animation transfer target sub-model 2D′ that are on which model correction processing is performed is correctly preserved.

In the embodiments of this disclosure, the computer device constructs the first local BV for the animation transfer source model and constructs the second local BV for the animation transfer target model, so that the N first local object BVs associated with the first object and the M second local object BVs associated with the second object may be obtained. A spatial expression of the animation transfer source model may be formed by using the N first local object BVs, then spatial semantics detection may be performed on first local object BVs that may be in contact in the N first local object BVs according to a contactable definition table, to obtain a spatial semantics detection result, and an effective interaction BV that satisfies the animation retargeting policy is sorted out from the N first local object BVs based on the spatial semantics detection result, thereby transferring spatial semantics information of the effective interaction BV to the second local object BV that satisfies the animation retargeting policy, to obtain a mapping BV. A calculation amount of spatial semantics detection can be greatly reduced by using the contactable definition table, thereby improving retargeting efficiency. In addition, in this embodiment of this disclosure, by transferring the spatial semantics information of the effective interaction BV, a transferred data volume is also reduced, and retargeting efficiency can be improved to some extent. In addition, the spatial semantics information of the effective interaction BV is transferred to the second local object BV satisfying the animation retargeting policy, which means that in this embodiment of this disclosure, the spatial semantics information of the effective interaction BV in the mapping source model is relatively precisely mapped to the corresponding second local object BV in the mapping target model, thereby improving the accuracy of spatial semantics transfer in the animation retargeting process. In this embodiment of this disclosure, model correction processing may be performed on the animation transfer target model including the mapping BV according to the model correction parameter determined according to the spatial semantics information, to obtain the animation transfer target model on which the model correction processing is performed. In this way, model correction processing may be automatically performed, so that spatial semantics information of the animation transfer target model on which the model correction processing is performed is kept consistent with spatial semantics information of the animation transfer source model without manual adjustment, thereby improving animation retargeting efficiency, and also improving accuracy of spatial semantics transfer in the animation retargeting process and maintaining accuracy of spatial semantics transfer, to improve consistency between animation data presented by the animation transfer target model and that presented by the animation transfer source model.

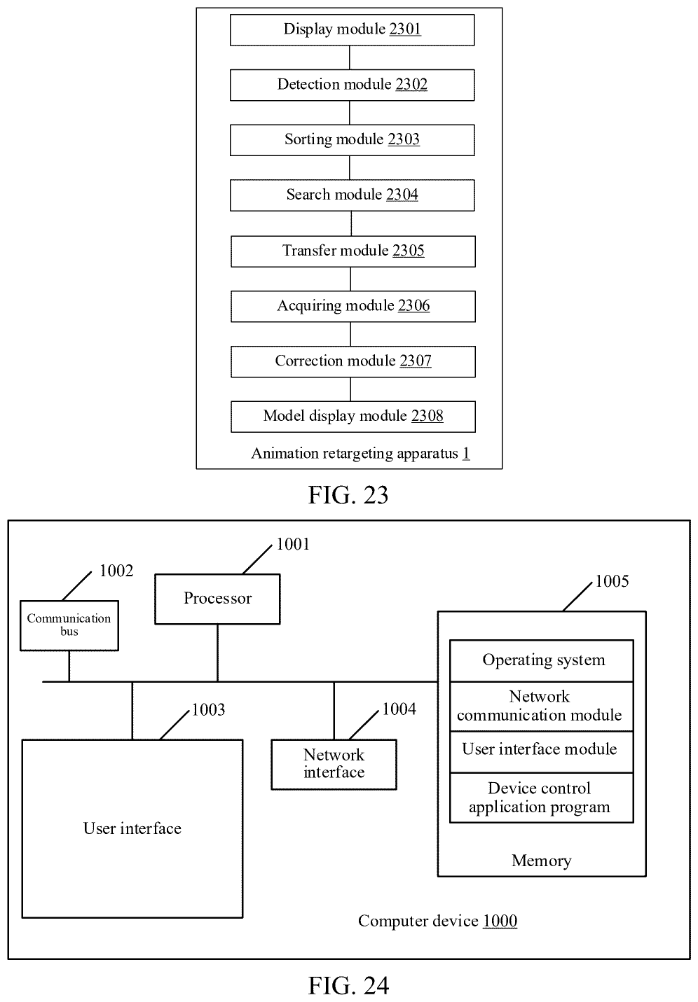

Based on the foregoing description of the animation retargeting method, an embodiment of this disclosure further provides an animation retargeting apparatus configured to implement the foregoing animation retargeting method. FIG. 23 is a schematic structural diagram of an animation retargeting apparatus according to an embodiment of this disclosure. The animation retargeting apparatus 1 may be a computer program (including program code) running in a computer device. For example, the animation retargeting apparatus 1 may be application software. The animation retargeting apparatus 1 may be configured to perform corresponding operations in the animation retargeting method provided in the embodiments of this disclosure. The animation retargeting apparatus 1 may include: a display module 2301, a detection module 2302, a sorting module 2303, a search module 2304, a transfer module 2305, an acquiring module 2306, a correction module 2307, and a model display module 2308.

The display module 2301 is configured to display, on an animation retargeting configuration interface, an animation transfer source model associated with a first object, an animation transfer target model associated with a second object, N first local object BVs associated with the first object, and M second local object BVs associated with the second object, N and M being both positive integers; one first local object BV including one local object of the first object; and one second local object BV including one local object of the second object; the detection module 2302 is configured to perform spatial semantics detection on the N first local object BVs, to obtain a spatial semantics detection result; the sorting module 2303 is configured to determine, based on the spatial semantics detection result, a first local object BV pair that is sorted out from the N first local object BVs and satisfies an animation retargeting policy as effective interaction BVs of the first object; the search module 2304 is configured to determine second local object BVs that are found in the M second local object BVs and satisfy the animation retargeting policy as to-be-transferred BVs; the transfer module 2305 is configured to transfer, when spatial semantics information of the effective interaction BVs is acquired based on the spatial semantics detection result, the spatial semantics information from the effective interaction BVs to the to-be-transferred BVs, to obtain transferred BVs that carry the spatial semantics information; the acquiring module 2306 is configured to acquire a model correction parameter determined from the spatial semantics information; the correction module 2307 is configured to perform, based on the model correction parameter, model correction processing on the animation transfer target model that includes the transferred BVs, to obtain an animation transfer target model on which model correction processing is performed; and the model display module 2308 is configured to display the animation transfer target model on which model correction processing is performed on the animation retargeting configuration interface, spatial semantics information of the animation transfer target model on which model correction processing is performed being kept consistent with spatial semantics information of the animation transfer source model.

In some embodiments, the N first local object BVs include a first local object BV i and a first local object BV j; i is not equal to j, and i and j are both positive integers less than or equal to N; the first local object BVᵢ and the first local object BVⱼ are local object BVs that satisfy a local contact condition and that are in a contactable definition table; and the contactable definition table is configured for the animation transfer source model; and the detection module 2302 is further configured to: acquire the first local object BVᵢ and the first local object BV j from the contactable definition table associated with the N first local object BVs; determine a first geometry attribute of the first local object BVᵢ and a second geometry attribute of the first local object BV j; determine, based on the first geometry attribute, the second geometry attribute, and a contact relationship that is indicated by the local contact condition, a first local contact surface of the first local object BV i and a second local contact surface of the first local object BV j; determine, based on the first local contact surface and the second local contact surface, a first closest point pair between the first local object BV i and the first local object BV j, where the first closest point pair includes a first closest point on the first local object BV i and a second closest point on the first local object BV j; determine a closest point distance between the first closest point and the second closest point, and determine the closest point distance between the first closest point and the second closest point as a first closest point distance between the first local object BV i and the first local object BV j; and determine the first closest point pair and the first closest point distance as the spatial semantics detection result between the first local object BV i and the first local object BV j.

In some embodiments, the first geometry attribute and the second geometry attribute are both sphere attributes; and the detection module 2302 is further configured to: determine a spherical center distance between a spherical center of the first local object BV i and a spherical center of the first local object BV j; and determine the closest point distance between the first closest point and the second closest point according to the spherical center distance, a radius of the first local object BV i, and a radius of the first local object BV j.

In some embodiments, the first geometry attribute is a sphere attribute, and the second geometry attribute is a capsule attribute; and the detection module 2302 is further configured to: determine, based on a spherical center distance between a spherical center of the first local object BV i and a spherical center of the first local object BV j, a radius of the first local object BV i, and a radius of the first local object BV j, the closest point distance between the first closest point and the second closest point if the contact relationship indicated by the local contact condition includes that the first local object BV i is located on a side surface of a sphere included in the first local object BV j.

In some embodiments, the first geometry attribute is a sphere attribute, and the second geometry attribute is a capsule attribute; and the detection module 2302 is further configured to: determine, based on a spherical center distance between a spherical center of the first local object BV i and a cylinder center line segment included in the first local object BV j, a radius of the first local object BV i, and a radius of the first local object BV j, the closest point distance between the first closest point and the second closest point if the contact relationship indicated by the local contact condition includes that the first local object BV i is located on a side surface of a cylinder included in the first local object BV j.

In some embodiments, the first geometry attribute is a capsule attribute, and the second geometry attribute is a capsule attribute; the first local object BV i includes a cylinder and a sphere; and the first local object BV j includes a cylinder and a sphere; and the detection module 2302 is further configured to: determine, if the contact relationship indicated by the local contact condition includes that a cylinder center line segment of the first local object BV i is not located on a side surface of a cylinder included in the first local object BV j and a cylinder center line segment of the first local object BV j is not located on a side surface of a cylinder included in the first local object BV i, a closest endpoint distance between the cylinder center line segment of the first local object BV i and the cylinder center line segment of the first local object BV j; and determine, based on the closest endpoint distance, a radius of the first local object BV i, and a radius of the first local object BV j, the closest point distance between the first closest point and the second closest point.

In some embodiments, the first geometry attribute is a capsule attribute, and the second geometry attribute is a capsule attribute; the first local object BV i includes a cylinder and a sphere; and the first local object BV j includes a cylinder and a sphere; and the detection module 2302 is further configured to: determine, if the contact relationship indicated by the local contact condition includes that in the first local object BV i and the first local object BV j, a target endpoint of a cylinder center line segment of any local object BV is located on a side surface of a cylinder of the other local object BV, a target distance between the target endpoint of the cylinder center line segment of the any local object BV and a cylinder center line segment of the other local object BV; and determine, based on the target distance, a radius of the first local object BV i, and a radius of the first local object BV j, the closest point distance between the first closest point and the second closest point.

In some embodiments, the detection module 2302 is further configured to: determine, if the contact relationship indicated by the local contact condition includes that the first closest point and the second closest point are respectively projected on respective cylinder center line segments and are located in the respective cylinder center line segments, that a distance from the first closest point to the first local object BV i is the radius of the first local object BV i and that a distance from the second closest point to the first local object BV j is the radius of the first local object BV j; determine a second closest point distance between a spatial straight line corresponding to the cylinder center line segment of the first local object BV i and a spatial straight line corresponding to the cylinder center line segment of the first local object BV j; and determine, based on the second closest point distance, the radius of the first local object BV i, and the radius of the first local object BV j, the closest point distance between the first closest point and the second closest point.

In some embodiments, the N first local object BVs include a first local object BV i and a first local object BV j; i is not equal to j, and i and j are both positive integers less than or equal to N; the animation retargeting policy includes an interaction detection policy, and the interaction detection policy includes an interaction distance threshold for performing interaction detection; and the sorting module 2303 is further configured to: acquire, based on the spatial semantics detection result, the first local object BVᵢ and the first local object BV j from the N first local object BVs, and determine the first closest point distance between the first local object BV i and the first local object BV j; and determine, if the first closest point distance between the first local object BV i and the first local object BV j is less than the interaction distance threshold, the first local object BVᵢ and the first local object BVⱼ as the first local object BV pair that is sorted out from the N first local object BVs and satisfies the animation retargeting policy.

In some embodiments, the effective interaction BVs include a first effective interaction BV and a second effective interaction BV, and the to-be-transferred BVs include a first to-be-transferred BV and a second to-be-transferred BV; the spatial semantics information includes a closest point pair between the first effective interaction BV and the second effective interaction BV, first spatial semantics information of the first effective interaction BV, and second spatial semantics information of the second effective interaction BV; the transferred BVs include a first transferred BV and a second transferred BV; and the closest point pair between the first effective interaction BV and the second effective interaction BV includes a closest point of the first effective interaction BV and a closest point of the second effective interaction BV; and the transfer module 2305 is further configured to: determine a first position point on the first to-be-transferred BV that has the same first spatial semantics information as that of the closest point of the first effective interaction BV, and determine a second position point on the second to-be-transferred BV that has the same second spatial semantics information as that of the closest point of the second effective interaction BV; transfer the first spatial semantics information of the closest point of the first effective interaction BV to the first position point, to obtain the first transferred BV carrying the first spatial semantics information; transfer the second spatial semantics information of the closest point of the second effective interaction BV to the second position point, to obtain the second transferred BV carrying the second spatial semantics information; and generate, based on the first transferred BV carrying the first spatial semantics information and the second transferred BV carrying the second spatial semantics information, the transferred BVs carrying the spatial semantics information.

In some embodiments, the apparatus further includes: a construction module, configured to: construct a first coordinate system based on the first effective interaction BV, and determine a vector pointing from an origin of the first coordinate system to the closest point of the first effective interaction BV as a local vector of the closest point of the first effective interaction BV; and a generation module, configured to: generate, based on the local vector of the closest point of the first effective interaction BV, the first spatial semantics information of the first effective interaction BV.

In some embodiments, the first effective interaction BV is a capsule; and the generation module is further configured to: determine a proportion coefficient corresponding to the closest point of the first effective interaction BV on an axial vector of the first local object BV i; project the local vector of the first effective interaction BV, to obtain a projection vector of the closest point of the first effective interaction BV; and generate, based on the proportion coefficient and the projection vector, the first spatial semantics information of the first effective interaction BV.

In some embodiments, the acquiring module 2306 is further configured to: determine the first transferred BV as an EEF in the animation transfer target model including the transferred BVs; use the first position point and the second position point as a second closest point pair between the first transferred BV and the second transferred BV; superpose, for a second position point in the second closest point pair, a closest point distance between the first effective interaction BV and the second effective interaction BV along a direction perpendicular to a surface of the first transferred BV, to obtain an interaction estimation point corresponding to the second position point; determine, based on the interaction estimation point corresponding to the second position point, the first position point in the second closest point pair, and an adjustment weight, an adjustment vector of the first transferred BV; and generate the model correction parameter based on the adjustment vector of the first transferred BV.

In some embodiments, the correction module 2307 is further configured to: perform, based on the adjustment vector of the first transferred BV, translation adjustment on the first transferred BV in the animation transfer target model, to obtain a first transferred BV on which translation adjustment is performed; and perform, based on the first transferred BV on which translation adjustment is performed, model correction processing on the animation transfer target model, to obtain an animation transfer target model on which model correction processing is performed.

In some embodiments, the animation retargeting configuration interface includes an animation transfer source model option and an animation transfer target model option, and the apparatus further includes: a model selection module, configured to: determine, in response to a trigger operation on the animation transfer source model option, a target frame of animation data in a plurality of frames of animation data included in target animation data, where the target frame of animation data corresponds to the animation transfer source model on which spatial semantics transfer is to be performed and that is associated with the first object; and select, from a transfer model database in response to a trigger operation on the animation transfer target model option, the animation transfer target model on which spatial semantics transfer is to be performed.

In some embodiments, the animation retargeting configuration interface includes a first BV initialization option and a second BV initialization option, and the display module 2301 is further configured to: display, in response to a trigger operation on the first BV initialization option, N first initial local object BVs associated with the first object; unbind the N first initial local object BVs from the animation transfer source model, to obtain unbound N first initial local object BVs; adjust, in response to an adjustment operation on the unbound N first initial local object BVs, the unbound N first initial local object BVs to obtain the N first local object BVs associated with the first object, and display the N first local object BVs associated with the first object on the animation retargeting configuration interface; display, in response to a trigger operation on the second BV initialization option, M second initial local object BVs associated with the second object; and adjust, in response to an adjustment operation on the M second initial local object BVs, the M second initial local object BVs to obtain the M second local object BVs associated with the second object, and display the M second local object BVs associated with the second object on the animation retargeting configuration interface. The adjustment operation includes at least one or more of the following: a scaling operation, a moving operation, and a rotating operation.

In the embodiments of this disclosure, the first local BV is constructed for the animation transfer source model and the second local BV is constructed for the animation transfer target model, so that the N first local object BVs associated with the first object and the M second local object BVs associated with the second object may be obtained. A spatial expression of the animation transfer source model may be formed by using the N first local object BVs, then spatial semantics detection may be performed on the N first local object BVs to obtain a spatial semantics detection result, and an effective interaction BV that satisfies the animation retargeting policy is sorted out from the N first local object BVs based on the spatial semantics detection result, thereby transferring spatial semantics information of the effective interaction BV to the second local object BV that satisfies the animation retargeting policy, to obtain a mapping BV. By directly transferring the spatial semantics information of the effective interaction BV, a transferred data volume is reduced, and retargeting efficiency can be improved to some extent. In addition, the spatial semantics information of the effective interaction BV is transferred to the second local object BV satisfying the animation retargeting policy, which means that in this embodiment of this disclosure, the spatial semantics information of the effective interaction BV in the mapping source model is relatively precisely mapped to the corresponding second local object BV in the mapping target model, thereby improving the accuracy of spatial semantics transfer in the animation retargeting process. In this embodiment of this disclosure, model correction processing may be performed on the animation transfer target model including the mapping BV according to the model correction parameter determined according to the spatial semantics information, to obtain the animation transfer target model on which the model correction processing is performed. In this way, model correction processing may be automatically performed, so that spatial semantics information of the animation transfer target model on which the model correction processing is performed is kept consistent with spatial semantics information of the animation transfer source model, thereby improving animation retargeting efficiency, and also improving accuracy of spatial semantics transfer in the animation retargeting process and maintaining accuracy of spatial semantics transfer, to improve consistency between animation data presented by the animation transfer target model and that presented by the animation transfer source model.

Based on the animation retargeting method and the animation retargeting apparatus provided in the foregoing embodiments, an embodiment of this disclosure further provides a computer device configured to implement the animation retargeting method. The animation retargeting apparatus may be a virtual apparatus located in the computer device. FIG. 24 is a schematic structural diagram of a computer device according to an embodiment of this disclosure. As shown in FIG. 24, the computer device 1000 may be a terminal device, for example, the terminal device 101 in the embodiment corresponding to FIG. 1, or may be a server, for example, the server 102 in the embodiment corresponding to FIG. 1. This is not limited herein. For ease of understanding, in this embodiment of this disclosure, an example in which the computer device is a terminal device is used. The computer device 1000 may include: a processor 1001, a network interface 1004, and a memory 1005. In addition, the computer device 1000 may further include: a user interface 1003, and at least one communication bus 1002. The communication bus 1002 is configured to implement communication between these components. The user interface 1003 may further include a standard wired interface and wireless interface. The network interface 1004 may include a standard wired interface and wireless interface (for example, a Wi-Fi interface) in one embodiment. The memory 1005 may be a high-speed RAM memory, or a non-volatile memory, for example, at least one magnetic disk storage. In one embodiment, the memory 1005 may be at least one storage apparatus that is located far away from the foregoing processor 1001. As shown in FIG. 24, the memory 1005 used as a computer-readable storage medium may include an operating system, a network communication module, a user interface module, and a device control application program.

The network interface 1004 in the computer device 1000 may further provide a network communication function. In the computer device 1000 shown in FIG. 24, the network interface 1004 may provide a network communication function. The user interface 1003 is mainly configured to provide an input interface for a user. The processor 1001 may be configured to invoke the device control application program stored in the memory 1005, to perform the descriptions for the animation retargeting method in the foregoing embodiment corresponding to FIG. 4 or FIG. 11, and may also perform the descriptions for the animation retargeting apparatus 1 in the foregoing embodiment corresponding to FIG. 23. Details are not described herein again. In addition, the description of beneficial effects of the same method is not described herein again.

In addition, an embodiment of this disclosure further provides a computer-readable storage medium. The computer-readable storage medium stores a computer program executed by the animation retargeting apparatus 1 mentioned above, and the computer program includes computer instructions. When executing the computer instructions, the processor can perform the descriptions of the animation retargeting method in the embodiment corresponding to FIG. 4 or FIG. 11. Therefore, details are not described herein again. In addition, the description of beneficial effects of the same method is not described herein again. For technical details that are not disclosed in the embodiment of the computer-readable storage medium involved in this disclosure, refer to the method embodiments of this disclosure. In an example, the computer instructions may be deployed to be executed on a computer device, or deployed to be executed on a plurality of computer devices at the same position, or deployed to be executed on a plurality of computer devices that are distributed in a plurality of positions and interconnected by using a communication network. A plurality of computer devices distributed at a plurality of places and interconnected by using a communication network may form a block chain system.

In addition, an embodiment of this disclosure further provides a computer program product, the computer program product may include a computer program, and the computer program may be stored in a computer-readable storage medium. When a processor of a computer device reads the computer program from the computer-readable storage medium, the processor may execute the computer program, to cause the computer device to perform the descriptions of the animation retargeting method in the embodiment corresponding to FIG. 4 or FIG. 11. Therefore, details are not described herein again. In addition, the description of beneficial effects of the same method is not described herein again. For technical details that are not disclosed in the embodiment of the computer program product involved in this disclosure, refer to the method embodiments of this disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive

It is noted that all or some procedures in the methods in the foregoing embodiments may be implemented by a program instructing related hardware. The computer program may be stored in a computer-readable storage medium. When being executed, the computer program may include the procedures according to the embodiments of the foregoing methods. The computer-readable storage medium may be a magnetic disk, an optical disc, a read-only memory (ROM), a random access memory (RAM), or the like.

What is disclosed above are some embodiments of this disclosure, and are not intended to limit the protection scope of this disclosure. It is noted that all or some of processes that implement the foregoing embodiments and equivalent modifications made in accordance with the aspects of this disclosure shall fall within the scope of this disclosure.

What is claimed is:

1. A method of animation retargeting, the method comprising:
displaying, on an animation retargeting configuration interface, an animation transfer source model associated with a first object, and an animation transfer target model associated with a second object, the first object comprising at least N first local objects, the second object comprising at least M second local objects, N and M being positive integers, the animation transfer source model comprising N first local object bounding volumes (BVs) respectively associated with the N first local objects of the first object, and the animation transfer target model comprising M second local object BVs respectively associated with the M second local objects of the second object;
performing spatial semantics detection on the N first local object BVs, to obtain a spatial semantics detection result;
determining, based on the spatial semantics detection result and from the N first local object BVs of the first object, effective interaction BVs including a pair of first local object BVs that satisfies an animation retargeting policy;
determining, from the M second local object BVs of the second object, to-be-transferred BVs that satisfy the animation retargeting policy;
transferring spatial semantics information of the effective interaction BVs to the to-be-transferred BVs to obtain transferred BVs that carry the spatial semantics information;
acquiring a model correction parameter based on the spatial semantics information;
performing, based on the model correction parameter, model correction processing on the animation transfer target model that comprises the transferred BVs, to obtain an updated animation transfer target model; and
displaying the updated animation transfer target model on the animation retargeting configuration interface.

2. The method according to claim 1, wherein:
the performing the spatial semantics detection comprises:
acquiring, from the N first local object BVs, a first BV and a second BV that satisfy a local contact condition defined in a contactable definition table associated with the N first local object BVs;
determining a first geometry attribute of the first BV and a second geometry attribute of the second BV;
determining, based on the first geometry attribute, the second geometry attribute, and a contact relationship that is indicated by the local contact condition, a first local contact surface of the first BV and a second local contact surface of the second BV;
determining, based on the first local contact surface and the second local contact surface, a first closest point pair between the first BV and the second BV, wherein the first closest point pair comprises a first closest point on the first BV and a second closest point on the second BV; and
determining a closest point distance between the first closest point and the second closest point; and
the spatial semantics detection result includes spatial semantics of the first BV and the second BV including the first closest point pair and the closest point distance.

3. The method according to claim 2, wherein:
the first geometry attribute and the second geometry attribute are of a sphere attribute; and
the determining the closest point distance comprises:
determining a spherical center distance between a first spherical center of the first BV and a second spherical center of the second BV; and
determining the closest point distance between the first closest point and the second closest point according to the spherical center distance, a first radius of the first BV, and a second radius of the second BV.

4. The method according to claim 2, wherein:
the first geometry attribute is of a sphere attribute, and the second geometry attribute is of a capsule attribute; and
the determining the closest point distance comprises:
determining, based on a spherical center distance between a first spherical center of the first BV and a second spherical center of the second BV, a first radius of the first BV, and a second radius of the second BV, the closest point distance between the first closest point and the second closest point when the contact relationship indicates that the first BV is located on a side surface of a sphere portion of the second BV.

5. The method according to claim 2, wherein:
the first geometry attribute is of a sphere attribute, the second geometry attribute is of a capsule attribute; and
the determining the closest point distance comprises:
determining, based on a spherical center distance between a spherical center of the first BV and a cylinder center line segment of the second BV, a first radius of the first BV, and a second radius of the second BV, the closest point distance between the first closest point and the second closest point when the contact relationship indicates that the first BV is located on a side surface of a cylinder portion of the second BV.

6. The method according to claim 2, wherein:
the first geometry attribute and the second geometry attribute are of a capsule attribute, the first BV comprises a first cylinder and a first sphere, the second BV comprises a second cylinder and a second sphere; and
the determining the closest point distance comprises:
determining, when the contact relationship indicates that a first cylinder center line segment of the first BV is not located on a side surface of the second cylinder of the second BV and a second cylinder center line segment of the second BV is not located on a side surface of the first cylinder of the first BV, a closest endpoint distance between the first cylinder center line segment of the first BV and the second cylinder center line segment of the second BV; and
determining, based on the closest endpoint distance, a first radius of the first BV, and a second radius of the second BV, the closest point distance between the first closest point and the second closest point.

7. The method according to claim 2, wherein:
the first geometry attribute and the second geometry attribute are of a capsule attribute, the first BV comprises a first cylinder and a first sphere, the second BV comprises a second cylinder and a second sphere; and
the determining the closest point distance comprises:
determining, when the contact relationship indicates that a first target endpoint of a first cylinder center line segment of the first BV is located on a side surface of the second cylinder of the second BV and a second target endpoint of a second cylinder center line segment of the second BV is located on a side surface of the first cylinder of the first BV, a target distance between the first target endpoint of the first cylinder center line segment of the first BV and the second target endpoint of the second cylinder center line segment of the second BV; and
determining, based on the target distance, a first radius of the first BV, and a second radius of the second BV, the closest point distance between the first closest point and the second closest point.

8. The method according to claim 2, wherein:
the first geometry attribute and the second geometry attribute are of a capsule attribute; and
the determining the closest point distance comprises:
determining, when the contact relationship indicates that the first closest point is projected on a first cylinder center line segment of the first BV and second closest point is projected on a second cylinder center line segment of the second BV, that a first distance from the first closest point to the first cylinder center line segment of the first BV is a first radius of the first BV and that a second distance from the second closest point to the second cylinder center line segment of the second BV is a second radius of the second BV;
determining a second closest point distance between the first cylinder center line segment of the first BV and the second cylinder center line segment of the second BV; and
determining, based on the second closest point distance, the first radius of the first BV, and the second radius of the second BV, the closest point distance between the first closest point and the second closest point.

9. The method according to claim 1, wherein:
the animation retargeting policy comprises an interaction detection policy, and the interaction detection policy comprises an interaction distance threshold for performing interaction detection; and
the method further comprises:
acquiring, from the N first local object BVs and based on the spatial semantics detection result, a first BV and a second BV;
determining a first closest point distance between the first BV and the second BV; and
determining, when the first closest point distance between the first BV and the second BV is less than the interaction distance threshold, the first BV and the second BV as the pair of first local object BVs.

10. The method according to claim 1, wherein:
the effective interaction BVs comprise a first effective interaction BV and a second effective interaction BV, and the to-be-transferred BVs comprise a first to-be-transferred BV and a second to-be-transferred BV;
the spatial semantics information comprises a closest point pair between the first effective interaction BV and the second effective interaction BV, first spatial semantics information of the first effective interaction BV, and second spatial semantics information of the second effective interaction BV;
the transferred BVs comprise a first transferred BV and a second transferred BV;
the closest point pair between the first effective interaction BV and the second effective interaction BV comprises a first closest point of the first effective interaction BV and a second closest point of the second effective interaction BV; and
the transferring the spatial semantics information comprises:
determining a first position point on the first to-be-transferred BV to correspond to the first closest point of the first effective interaction BV;
determining a second position point on the second to-be-transferred BV to correspond to the second closest point of the second effective interaction BV;
transferring the first spatial semantics information of the first effective interaction BV to the first to-be-transferred BV based on the first position point, to obtain the first transferred BV carrying the first spatial semantics information;
transferring the second spatial semantics information of the second effective interaction BV to the second to-be-transferred BV based on the second position point, to obtain the second transferred BV carrying the second spatial semantics information; and
generating, based on the first transferred BV carrying the first spatial semantics information and the second transferred BV carrying the second spatial semantics information, the transferred BVs carrying the spatial semantics information.

11. The method according to claim 10, further comprising:
constructing a first coordinate system based on the first effective interaction BV;
determining a local vector of the first closest point of the first effective interaction BV, the local vector pointing from an origin of the first coordinate system to the first closest point; and
generating, based on the local vector of the first closest point of the first effective interaction BV, the first spatial semantics information of the first effective interaction BV.

12. The method according to claim 11, wherein:
the first effective interaction BV is a capsule; and
the generating the first spatial semantics information of the first effective interaction BV comprises:
determining a proportion coefficient corresponding to the first closest point of the first effective interaction BV on an axial vector of the first effective interaction BV;
projecting the local vector, to obtain a projection vector of the first closest point of the first effective interaction BV; and
generating, based on the proportion coefficient and the projection vector, the first spatial semantics information of the first effective interaction BV.

13. The method according to claim 10, wherein the acquiring the model correction parameter comprises:
determining, based on the animation transfer target model comprising the transferred BVs in the animation retargeting configuration interface, that the first transferred BV corresponds to an End-effector (EEF);
forming a second closest point pair between the first transferred BV and the second transferred BV, the second closest point pair including the first position point and the second position point;
superposing, on the second position point in the second closest point pair, a closest point distance between the first effective interaction BV and the second effective interaction BV along a direction perpendicular to a surface of the first transferred BV, to obtain an interaction estimation point;
determining, based on a difference between the interaction estimation point and the first position point, and an adjustment weight, an adjustment vector of the first transferred BV; and
generating the model correction parameter based on the adjustment vector of the first transferred BV.

14. The method according to claim 13, wherein the performing the model correction processing comprises:
performing, based on the adjustment vector of the first transferred BV, a translation adjustment on the first transferred BV in the animation transfer target model, to obtain an updated first transferred BV; and
performing, based on the updated first transferred BV, the model correction processing on the animation transfer target model, to obtain the updated animation transfer target model.

15. The method according to claim 1, wherein:
the animation retargeting configuration interface comprises an animation transfer source model option and an animation transfer target model option; and
the method further comprises:
determining, in response to a trigger operation on the animation transfer source model option, a target frame of animation data from a plurality of frames of animation data in target animation data, the target frame of animation data including the animation transfer source model; and
selecting, in response to a trigger operation on the animation transfer target model option, the animation transfer target model from a transfer model database.

16. The method according to claim 1, wherein:
the animation retargeting configuration interface comprises a first BV initialization option and a second BV initialization option; and
the displaying the animation transfer source model and the animation transfer target model comprises:
displaying, in response to a trigger operation on the first BV initialization option, N first initial local object BVs associated with the first object;
unbinding the N first initial local object BVs from the animation transfer source model, to obtain unbound N first initial local object BVs;
adjusting, in response to an adjustment operation on the unbound N first initial local object BVs, the unbound N first initial local object BVs to obtain the N first local object BVs associated with the first object;
displaying the N first local object BVs associated with the first object on the animation retargeting configuration interface;
displaying, in response to a trigger operation on the second BV initialization option, M second initial local object BVs associated with the second object;
adjusting, in response to an adjustment operation on the M second initial local object BVs, the M second initial local object BVs to obtain the M second local object BVs associated with the second object; and
displaying the M second local object BVs associated with the second object on the animation retargeting configuration interface.

17. An information processing apparatus for animation retargeting, comprising processing circuitry configured to:
display, on an animation retargeting configuration interface, an animation transfer source model associated with a first object, and an animation transfer target model associated with a second object, the first object comprising at least N first local objects, the second object comprising at least M second local objects, N and M being positive integers, the animation transfer source model comprising N first local object bounding volumes (BVs) respectively associated with the N first local objects of the first object, and the animation transfer target model comprising M second local object BVs respectively associated with the M second local objects of the second object;
perform spatial semantics detection on the N first local object BVs, to obtain a spatial semantics detection result;
determine, based on the spatial semantics detection result and from the N first local object BVs of the first object, effective interaction BVs including a pair of first local object BVs that satisfies an animation retargeting policy;
determine, from the M second local object BVs of the second object, to-be-transferred BVs that satisfy the animation retargeting policy;
transfer spatial semantics information of the effective interaction BVs to the to-be-transferred BVs to obtain transferred BVs that carry the spatial semantics information;
acquire a model correction parameter based on the spatial semantics information;
perform, based on the model correction parameter, model correction processing on the animation transfer target model that comprises the transferred BVs, to obtain an updated animation transfer target model; and
display the updated animation transfer target model on the animation retargeting configuration interface.

18. The information processing apparatus according to claim 17, wherein
the processing circuitry is configured to:
acquire, from the N first local object BVs, a first BV and a second BV that satisfy a local contact condition defined in a contactable definition table associated with the N first local object BVs;
determine a first geometry attribute of the first BV and a second geometry attribute of the second BV;
determine, based on the first geometry attribute, the second geometry attribute, and a contact relationship that is indicated by the local contact condition, a first local contact surface of the first BV and a second local contact surface of the second BV;
determine, based on the first local contact surface and the second local contact surface, a first closest point pair between the first BV and the second BV, wherein the first closest point pair comprises a first closest point on the first BV and a second closest point on the second BV; and
determine a closest point distance between the first closest point and the second closest point; and
the spatial semantics detection result includes spatial semantics of the first BV and the second BV including the first closest point pair and the closest point distance.

19. The information processing apparatus according to claim 18, wherein:
the first geometry attribute and the second geometry attribute are of a sphere attribute; and
the processing circuitry is configured to:
determine a spherical center distance between a first spherical center of the first BV and a second spherical center of the second BV; and
determine the closest point distance between the first closest point and the second closest point according to the spherical center distance, a first radius of the first BV, and a second radius of the second BV.

20. A non-transitory computer-readable storage medium storing instructions which when executed by at least one processor cause the at least one processor to perform:
displaying, on an animation retargeting configuration interface, an animation transfer source model associated with a first object, and an animation transfer target model associated with a second object, the first object comprising at least N first local objects, the second object comprising at least M second local objects, N and M being positive integers, the animation transfer source model comprising N first local object bounding volumes (BVs) respectively associated with the N first local objects of the first object, and the animation transfer target model comprising M second local object BVs respectively associated with the M second local objects of the second object;
performing spatial semantics detection on the N first local object BVs, to obtain a spatial semantics detection result;
determining, based on the spatial semantics detection result and from the N first local object BVs of the first object, effective interaction BVs including a pair of first local object BVs that satisfies an animation retargeting policy;
determining, from the M second local object BVs of the second object, to-be-transferred BVs that satisfy the animation retargeting policy;
transferring spatial semantics information of the effective interaction BVs to the to-be-transferred BVs to obtain transferred BVs that carry the spatial semantics information;
acquiring a model correction parameter based on the spatial semantics information;
performing, based on the model correction parameter, model correction processing on the animation transfer target model that comprises the transferred BVs, to obtain an updated animation transfer target model; and
displaying the updated animation transfer target model on the animation retargeting configuration interface.
